(19) United States
(12) Patent Application Publication
(10) Pub. No.: US 2024/0237858 A1
(43) Pub. Date: Jul. 18, 2024

(54) Rotary Grater And/Or Slicer

(71) Applicant: Revise Products LLC, Santa Cruz, CA (US)

(72) Inventor: Stephan Bianchi, Santa Cruz, CA (US)

(21) Appl. No.: 18/415,641

(22) Filed: Jan. 17, 2024

Related U.S. Application Data
(60) Provisional application No. 63/439,553, filed on Jan. 17, 2023.
(60) Provisional application No. 63/581,280, filed on Sep. 7, 2023.

(51) Int. Cl. A47J 43/25; B26D 5/14; B26D 7/06; B26D 7/26

(52) U.S. Cl. CPC A47J 43/255; B26D 5/14; B26D 7/0641; B26D 7/2614; B26D 2210/02

(57) ABSTRACT

A rotary grater and/or slicer includes a grater body, the grater body including a cutter housing portion and a vertical hopper portion connected to the cutter housing portion, the vertical hopper portion of the grater body being configured to hold a workpiece for grating; a rotatable cutting device, the rotatable cutting device configured to be rotatably disposed inside the cutter housing portion of the grater body, the rotatable cutting device comprising a plurality of blade members for grating the workpiece; and a rotary input device coupled to the rotatable cutting device, the rotary input device configured to rotate the rotatable cutting device. The vertical hopper portion is configured to serve as a handle for the rotary grater and/or slicer, and the vertical hopper portion is used for feeding the workpiece to the rotatable cutting device.

### CROSS-REFERENCE TO RELATED APPLICATIONS

This patent application claims priority to U.S. Provisional Patent Application No. 63/439,553, entitled “Gravity-Fed Hand-Held Rotary Grater/Slicer Device, System and Method”, filed on Jan. 17, 2023, and U.S. Provisional Patent Application No. 63/581,280, entitled “Gravity-Operated Rotary Grater/Slicer”, filed on Sep. 7, 2023, the disclosure of each of which is hereby incorporated by reference as if set forth in its entirety herein.

### STATEMENT REGARDING FEDERALLY SPONSORED RESEARCH OR DEVELOPMENT

Not Applicable.

### NAMES OF THE PARTIES TO A JOINT RESEARCH AGREEMENT

Not Applicable.

### INCORPORATION BY REFERENCE OF MATERIAL SUBMITTED ON A COMPACT DISK

Not Applicable.

### BACKGROUND OF DISCLOSURE

### 1. Field of the Disclosure

The disclosure generally relates to a rotary grater and/or slicer. More particularly, the disclosure relates to a gravity-fed rotary grater and/or slicer for grating and/or slicing a variety of different workpieces, such as food items.

### 2. Background

Cooks grate or slice comestibles to spread or mix them together and to thin them for fast and even cooking. Knives can be used, but it takes time and skill to make uniform cuts and to avoid cutting fingers. Flat graters, tower graters and mandolins allow faster, more even cuts and prevent serious loss of flesh, but still allow scraping and skinning of fingers. A number of utensils have been devised to speed up and neaten the process. In addition to cheese slicers and cheese grinders, there are also meat grinders, pepper grinders, coffee grinders, mixers, and even blenders used to granulate or slice foodstuffs. The former three devices employ a rotating helical plunger that feeds material into stationary cutters. The latter three employ rotating blades. Cheese, nut and butter graters or slicers feed materials into cutters arranged on a rotating disk or drum. Cylindrical drums grate more evenly, as all cutters are traveling at the same speed over equivalent distance. These devices are operated by a hand crank or electric motor, rotary motion being more accurate and efficient than reciprocating motion. Hand-held versions of modest size are intended for tabletop use.

People find it tiring to push on a plunger while cranking. Screw drives are slow and add complexity and weakness. Spring plungers add complexity, difficulty in cleaning and limit workpiece size.

Currently, there are two major classes of slicers and/or graters. One is bolted to a wall or clamped or suctioned to a countertop to process food in the kitchen. The other is a smaller portable device that grates hard cheese, nuts, chocolate or a cold stick of butter, often used at the table.

If the grater or mill is mounted securely on a countertop, tabletop, wall or other surface, the user can crank with one hand while pushing the plunger with the other, applying body weight if necessary. Stationary graters or mills feature a top-mounted funnel-shaped hopper. If they rely on gravity alone to press workpieces into rotating blades, they only work with pellet-shaped materials such as grains or peppercorns or nuts, as larger objects may jam. Hoppers are typically centered atop the drums, and not tangent to them: therefore, the drum is primarily pushing the material laterally, one half pushing it upwards while the other half pushes downwards. Often, the hoppers are funnel-shaped, which would cause solid chunks to jams. Plungers are employed to feed vegetables and other larger materials into a grater.

Portable graters are typically held in one hand, which simultaneously squeezes the plunger into the hopper while the other hand cranks a drum or disk. Continual squeezing is fatiguing. In any case, the plunger generally limits the length of material that can be introduced. Long objects such as carrots must be cut short. Objects longer than the hopper is deep tend to slide sideways off the surface of the plunger. Plungers themselves can advance into the cutters, introducing foreign substances into prepared food.

A number of tabletop cheese mills feature grating drums rotating on a vertical axis. The drum is enclosed, the enclosure widened at one side to form a hopper. The far wall of the hopper opposite the drum serves as a direct-drive plunger. The user holds the enclosure in one hand, squeezing the plunger towards the drum with one hand while cranking the drum with the other hand. The user's hand must surround the drum as well as the hopper. Although, most graters have drums turning on a horizontal axis.

Instead of levers, pressure can be applied by screws turned by large opposing knobs, but they slow the process. They complicate mechanisms, making them more expensive, more delicate and harder to clean.

As such, there is a need for a rotary grater and/or slicer that provides one or more of the following benefits: (1) the grater automatically feeds itself as the crank is turned, (2) the grater requires minimal force to crank, (3) the grater can be used easily by left- and right-handers, (4) the grater can process both hard and soft materials, (5) the grater can process spherical materials, (6) the grater can process materials of limitless length, (7) the grater is simple to manufacture, (8) the grater is simple to assemble, (9) the grater is easy to clean, (10) the grater takes up minimal storage space, (11) the grater takes up minimal space on a table or countertop, and (12) the grater retains processed or unprocessed material without spillage.

There is also a need for a rotary grater and/or slicer that can be held steady, can empty automatically into a vessel, and/or that can retain alternate parts.

### SUMMARY OF THE DISCLOSURE

Accordingly, the present disclosure is directed to a rotary grater and/or slicer that substantially obviates one or more problems resulting from the limitations and deficiencies of the related art.

In accordance with one or more embodiments of the present disclosure, there is provided a rotary grater that comprises a rotary grater and/or slicer that includes a grater body, the grater body including a cutter housing portion and a vertical hopper portion connected to the cutter housing portion, the vertical hopper portion of the grater body being configured to hold a workpiece for grating; a rotatable cutting device, the rotatable cutting device configured to be rotatably disposed inside the cutter housing portion of the grater body, the rotatable cutting device comprising a plurality of blade members for grating the workpiece; and a rotary input device coupled to the rotatable cutting device, the rotary input device configured to rotate the rotatable cutting device. In these one or more embodiments, the vertical hopper portion is configured to serve as a handle for the rotary grater and/or slicer, and the vertical hopper portion is used for feeding the workpiece to the rotatable cutting device.

In a further embodiment of the present disclosure, the rotatable cutting device comprises a rotatable drum with the blade members, and the rotary input device comprises a crank connected to the rotatable drum.

In yet a further embodiment, one wall of the vertical hopper portion is tangent to the rotatable drum.

In still a further embodiment, the one wall of the vertical hopper portion that is tangent to the rotatable drum or another wall portion beneath the one wall comprises a dam preceded by a cavity in order to discourage grated material from wedging between the rotatable drum and the grater body.

In yet a further embodiment, a wall area of the vertical hopper portion above the tangency is provided with sharp-edged horizontal ridges to prevent the workpiece from rolling.

In still a further embodiment, the crank is mounted on one edge of the rotatable drum.

In yet a further embodiment, the crank is removably coupled to the rotatable drum such that the crank is able to mounted interchangeable on a first side or a second side of the rotatable drum, the first side of the rotatable drum being oppositely disposed relative to the second side of the rotatable drum.

In still a further embodiment, the crank is removably coupled to the rotatable drum such that the crank is reversible from a first configuration where a handle portion of the crank projects outwardly from the rotary grater and/or slicer to a second configuration where the handle portion of the crank projects inwardly towards a centerline of the rotary grater and/or slicer, the second configuration enabling the rotary grater to be more compact for storage.

In yet a further embodiment, the crank is affixed to the rotatable drum by a bayonet mount.

In still a further embodiment, the bayonet mount is secured by a resilient protrusion pressing out from the rotatable drum to engage a side of a tooth protruding inwards from a ring affixed to the crank.

In yet a further embodiment, the bayonet mount is secured by a resilient protrusion pressing out from the rotatable drum to engage a side of a tooth protruding inwards from a bore surrounding axis of the crank.

In still a further embodiment, inner edges of lips of the rotatable drum are flared inwards to retain shavings when an axis of the rotatable drum is horizontal.

In yet a further embodiment, the blade members on the rotatable drum are arranged such that the workpiece can fully contact the drum between the blade members so that the blade members are able to make clear cuts through the workpiece.

In still a further embodiment, the vertical hopper portion comprises a top lip that is flared to prevent the rotary grater and/or slicer from slipping from a grip of a user.

In yet a further embodiment, the rotary grater and/or slicer further comprises a stand configured to maintain the vertical hopper portion in a generally vertical orientation when rotary grater and/or slicer is not being used for grating.

In still a further embodiment, the rotary grater and/or slicer further comprises a spring-loaded plunger configured to be received within the vertical hopper portion.

In yet a further embodiment, the plunger is configured to be clipped into place within the vertical hopper portion.

In still a further embodiment, the plunger is configured to be clipped into place at two or more locations so as to accommodate different workpiece volumes.

In yet a further embodiment, a workpiece engagement face of the plunger is provided with sharp-edged ridges parallel to a rotational axis of the rotatable cutting device to prevent the workpieces from rolling.

In still a further embodiment, sections of the plunger are held together by a rotatable key.

In yet a further embodiment, the rotary grater and/or slicer further comprises a plurality of gears to provide a mechanical advantage for a user of the rotary grater and/or slicer.

In still a further embodiment, one or more outer rims of the rotatable cutting device are provided with one or more of the plurality of gears that engage with a spur gear mounted on a crank or crankshaft.

It is to be understood that the foregoing general description and the following detailed description are merely exemplary and explanatory in nature. As such, the foregoing general description and the following detailed description should not be construed to limit the scope of the appended claims in any sense.

### BRIEF DESCRIPTION OF THE SEVERAL VIEWS OF THE DRAWINGS

The rotary grater will now be described, by way of example, with reference to the accompanying drawings, in which:

FIG. 1 is a right side-top perspective view of a rotary grater and/or slicer disposed in a stand, according to a first illustrative embodiment;

FIG. 2 is a right side-bottom perspective view of the rotary grater and/or slicer of FIG. 1 disposed in the stand, wherein a drum is stored in a bottom recess of the stand;

FIG. 3 is a right side elevational view of the rotary grater and/or slicer of FIG. 1 disposed in the stand;

FIG. 4 is a front elevational view of the rotary grater and/or slicer of FIG. 1 disposed in the stand;

FIG. 5 is a rear elevational view of the rotary grater and/or slicer of FIG. 1 disposed in the stand;

FIG. 6 is a left side elevational view of the rotary grater and/or slicer of FIG. 1 disposed in the stand;

FIG. 7 is a longitudinal cross-sectional view of the stand and rotary grater and/or slicer of FIG. 1;

FIG. 8 is a top plan view of the rotary grater and/or slicer of FIG. 1 disposed in the stand;

FIG. 9 is a bottom plan view of the stand and rotary grater and/or slicer of FIG. 1;

FIG. 10 is a left side-bottom perspective view of the rotary grater and/or slicer of FIG. 1;

FIG. 11 is a right side-top perspective view of the rotary grater and/or slicer of FIG. 1;

FIG. 12 is a right side elevational view of the rotary grater and/or slicer of FIG. 1;

FIG. 13 is a rear elevational view of the rotary grater and/or slicer of FIG. 1;

FIG. 14 is a left side elevational view of the rotary grater and/or slicer of FIG. 1;

FIG. 15 is a front elevational view of the rotary grater and/or slicer of FIG. 1;

FIG. 16 is a top plan view of the rotary grater and/or slicer of FIG. 1;

FIG. 17 is a bottom plan view of the rotary grater and/or slicer of FIG. 1;

FIG. 18 is an exploded perspective view of the rotary grater and/or slicer of FIG. 1;

FIG. 19 is an exploded perspective view of an alternative fixed-type crank assembly that may be used in the rotary grater and/or slicer of FIG. 1;

FIG. 20 is a top plan view of the pivot-type crank assembly of the rotary grater and/or slicer of FIG. 1;

FIG. 21 is a right side elevation view of the pivot-type crank assembly of FIG. 20;

FIG. 22 is a longitudinal cross-sectional view of the pivot-type crank assembly of FIG. 20, wherein the section is generally cut along the cutting-plane line 22-22 in FIG. 21;

FIG. 23 is a partially exploded longitudinal cross-sectional view of the pivot-type crank assembly of FIG. 20, which is similar to the longitudinal cross-sectional view of FIG. 22 except that the crank is shown exploded from the crankshaft;

FIG. 24 is a top plan view of a fixed-type crank assembly of a rotary grater and/or slicer, according to a second illustrative embodiment;

FIG. 25 is a right side elevation view of the fixed-type crank assembly of FIG. 24;

FIG. 26 is a longitudinal cross-sectional view of the fixed-type crank assembly of FIG. 24;

FIG. 27 is a left side elevation view of the fixed-type crank assembly of FIG. 24;

FIG. 28 is an enlarged perspective view of an end of a crankshaft of the fixed-type crank assembly of FIG. 24;

FIG. 29 is a front elevational view of a rotary grater and/or slicer, according to the second illustrative embodiment;

FIG. 30 is a right side elevational view of the rotary grater and/or slicer of FIG. 29;

FIG. 31 is a side-top perspective view of a hopper plunger of a rotary grater and/or slicer, according to an illustrative embodiment;

FIG. 32 is a side-bottom perspective view of the hopper plunger of FIG. 31;

FIG. 33 is an exploded perspective view of the hopper plunger of FIG. 31;

FIG. 34 is a right side elevational view of a stand of a rotary grater and/or slicer, according to an illustrative embodiment;

FIG. 35 is a front elevational view of the stand of FIG. 34;

FIG. 36 is a left side elevational view of the stand of FIG. 34;

FIG. 37 is a rear elevational view of the stand of FIG. 34;

FIG. 38 is a top-side perspective view of the stand of FIG. 34;

FIG. 39 is a bottom-side perspective view of the stand of FIG. 34;

FIG. 40 is a top plan view of the stand of FIG. 34;

FIG. 41 is a bottom plan view of the stand of FIG. 34;

FIG. 42 is a bottom plan view of a bottom plate of the stand of FIG. 34 with first alternative methods for engaging the stand with a countertop;

FIG. 43 is another bottom plan view of the bottom plate of the stand of FIG. 34 with second alternative methods for engaging the stand with a countertop;

FIG. 44 is a cross-sectional view of the bottom plate of the stand in FIG. 42, wherein the section is generally cut along the cutting-plane line 44-44 in FIG. 42;

FIG. 45 is a cross-sectional view of the bottom plate of the stand in FIG. 43, wherein the section is generally cut along the cutting-plane line 45-45 in FIG. 43′

FIG. 46 is a side-top perspective view of a rotary grater and/or slicer, according to a third illustrative embodiment;

FIG. 47 is another side-top perspective view of the rotary grater and/or slicer of FIG. 46, wherein the crank handle has been inverted and the plunger has been removed;

FIG. 48 is a first longitudinal cross-sectional view of the rotary grater and/or slicer of FIG. 46, wherein the lower sleeve of the plunger is retracted into the upper sleeve;

FIG. 49 is a second longitudinal cross-sectional view of the rotary grater and/or slicer of FIG. 46, wherein the lower sleeve of the plunger is extended from the upper sleeve;

FIG. 50 is an enlarged detail sectional view of an encircled portion “50” in the longitudinal cross-sectional view of FIG. 49;

FIG. 51 is a perspective view of a rotatable drum of a rotary grater and/or slicer, according to an illustrative embodiment;

FIG. 52 is a longitudinal cross-sectional view of the rotatable drum of FIG. 51;

FIG. 53 is a perspective view of a rotatable drum of a rotary grater and/or slicer, according to another illustrative embodiment;

FIG. 54 is a longitudinal cross-sectional view of the rotatable drum of FIG. 53;

FIG. 55 is a perspective view of a rotatable drum of a rotary grater and/or slicer, according to yet another illustrative embodiment;

FIG. 56 is a perspective view of a rotatable drum of a rotary grater and/or slicer, according to still another illustrative embodiment;

FIG. 57 is a perspective view of a crank and rotatable drum of a rotary grater and/or slicer, according to an illustrative embodiment;

FIG. 58 is a side-top perspective view of a rotary grater and/or slicer, according to a fourth illustrative embodiment;

FIG. 59 is a longitudinal cross-sectional view of the rotary grater and/or slicer of FIG. 58;

FIG. 60 is an enlarged detail sectional view of an encircled portion “60” in the longitudinal cross-sectional view of FIG. 59;

FIG. 61 is an exploded perspective view of the rotary grater and/or slicer of FIG. 58; and

FIG. 62 is a side-top perspective view of a rotary grater and/or slicer, according to a fifth illustrative embodiment.

Throughout the figures, the same parts are always denoted using the same reference characters so that, as a general rule, they will only be described once.

### DETAILED DESCRIPTION OF ILLUSTRATIVE EMBODIMENTS

In one or more embodiments, a gravity-fed hand-held slicer/grater comprises a drum bearing cutters rotating within a horizontal barrel. The barrel is located roughly tangent to a vertical hopper that serves as a handle. The cutters, which can be full width or fine, face downwards and turn down towards the hopper. A crank is affixed to the drum so as to be able to rotate it. The crank can be affixed so as to swivel out and in on a pin. Like the lever on a nail clipper, it can be introduced from the side into a notch in the shaft. In this case, the shaft can be squared so as to be keyed to the gear. The lever can be inverted to conserve space, and mounted on either side of the grater. The crank can instead be affixed via bayonet mount, which would be a simpler, more solid structure, but less convenient for tabletop use.

In one or more embodiments, to avoid pushing the workpiece upwards, the interface between the hopper and drum is confined to the descending upper side of the drum—one quadrant.

In one or more embodiments, the cutters can be spaced such that, after each cut, the workpiece can drop down between them for the next pass. To permit the workpiece to drop down without interference, the cutter can be singular, or cutters can be spaced 90, 120, or 180 degrees apart. They can extend the full width of the drum to produce full width slices. To slice with a smoother sawing instead of a chiseling motion, they can be angled to spiral around the drum in the manner of helices.

In one or more embodiments, to produce strips or strings instead of broad slices, the blades can be reduced to a fraction of the width. In that case, they can be staggered, overlapping to remove the entire bottom surface of the workpiece in two, three or four passes. This spacing reduces the strength required of the user, though it increases the number of cranking cycles and the time required to process the material. (It may also increase the frictional resistance.) The smaller the circumferential distances between cutters, the smoother the rotations of the drum.

In one or more embodiments, for grating, tiny cutters can be spread over the entirety of the drum. Cutters can be pressed, punched and/or etched out of stainless-steel drums, or blades can be molded or swaged into plastic ones.

The rotary grater and/or slicer, which is described in the illustrative embodiments hereinafter, is useful for processing foodstuffs, such as potatoes, carrots and soft cheeses, Parmesan cheese, chocolate, and nutmeg. A vertical hopper doubles as a handle. Gravity feeds the material into cutters arrayed on a rotating drum. The cutters, rotating downwards into a narrowing channel, enhance the downward force, advancing the workpiece, slicing or shredding it, and eliminating it through an open end of the drum. Advantageously, the rotary grater and/or slicer can be used to slice and/or grate produce, such as potatoes and carrots in the kitchen, or to grate Parmesan cheese, nuts and spices at the table.

In one or more embodiments, a vertical hopper is wide enough to accept a stick of butter, a pickle, a carrot, or a banana, but narrow enough to serve as a handle. Material is fed into the rotating drum by gravity. The blades themselves assist by driving the material into a narrowing channel from which it can escape only by passing through the drum. Material length is not limited and the longer the material, the heavier and more force is applied.

In one or more embodiments, the drum helps feed the material in the following way: The hopper is placed tangent to the drum, so that as it rotates, the blades pinch the material, capturing it and guiding it into a narrowing space. The blades are spaced so that they drive through the material from one side to the other one layer at a time. Then, the material can drop down ready for the next cut.

In one or more embodiments, material is prevented from wedging between the drum and the barrel by a dam crossing at the tangent point. A cavity preceding it recirculates material blocked by the dam.

In one or more embodiments, for grating smaller chunks of harder materials such as Parmesan cheese or nuts, a spring-loaded plunger provides further pressure. Because this portable grater stands upright, it takes up little space on the table. To prevent gratings from littering the tabletop, the open ends of the grating drum can curve inwards. The grater can be tilted and shaken to evacuate gratings before being set down.

In one or more embodiments, a self-contained plunger can be provided to contain and advance material. The exterior of the plunger is relatively smooth for easy cleaning. If it does need to be cleaned inside, it can be disassembled with a screwdriver, or preferably, a coin. A keyed shaft, inserted in the upper plunger and turned a quarter turn clockwise, snaps in place to hold the upper and lower portions of the plunger together around a coil compression spring. Pins on the lower end of the key keep the two portions of the plunger together, while pins on the upper end of the key keep the key within the plunger. (The plunger face seen in the drawings can be permanently glued in place on the lower portion.)

In one or more embodiments, the vertical hopper takes up minimal surface area, reducing tabletop clutter. It can be sized to accept a stick of cold butter. The ends of the grating drum can be curved inwards to keep shavings from littering the tabletop. (It is less likely this would be desirable for a slicing drum.)

In one or more embodiments, the vertical hopper is positioned to one side of the grating drum so the blades attack the material from the side, then drive it down against the hopper's tangent far wall, compressing it as it reaches the cut-off point. A horizontal dam across the hopper wall roughly perpendicular to the wall of the drum catches material before it can be wedged between the hopper wall and the drum. The dam is the lower rim of a bay that captures and recirculates the material blocked by the dam.

In one or more embodiments, above the dam, horizontal ridges with sharp edges pointed downward prevent the rotating drum from rolling materials against the hopper wall instead of slicing into them.

In one or more embodiments, when not in use, the crank, unless it is integrated into the drum itself, by can be inverted to nest alongside the hopper. In the case of the discrete crank, notches mating with the drum can secure the crank, keeping it from turning away from the hopper.

In one or more embodiments, sprung bumps on the drum or crankshaft engage with tabs arranged alongside the inner wall of the crank ring or crankshaft bore to keep the parts locked in place while in use.

In one or more embodiments, a spring-loaded telescoping plunger can be clipped within the hopper at various heights to add downward force to different volumes of workpieces.

In one or more embodiments, the crank can drive the drum directly, or it can turn on a driveshaft so as to be geared down, requiring less strength of the user. Placing the crank axis closer to the grip minimizes the tendency of the device to flop about when cranked.

In one or more embodiments, the unit can be mounted in a stand that can funnel proceed material into a bowl or other vessel. The stand can be secured to a work surface.

In one or more embodiments, a gravity-fed rotary grater comprises a drum bearing one or more external cutters and rotatably constrained within a barrel-shaped enclosure. A hopper having vertical walls is situated tangent to one edge of the drum which serves as its bottom wall. A crank is affixed to the drum such that it can be inverted for storage as well as transferred from side-to-side for left- or right-handers. It also reduces packaging and drawer space without risking loss of parts. Turning the crank rotates the drum such that its blades engage with the workpiece, advancing it along the far wall of the hopper as they cut into it.

In one or more embodiments, the gravity-fed rotary grater can be used to slice or shred vegetables, cheese or other materials to prepare them for cooking or mixing them into salads. It can also be used to add condiments such as hard cheeses, nuts or chocolate to taste at the table.

In one or more embodiments, the gravity-driven feed can be employed with or without a plunger. Without a plunger, the length of the workpiece can be infinite. However, a plunger is of value when hard materials must be pressed against fine grating teeth, which would fail to advance them without assistance. A self-contained telescoping plunger can be positioned at one or another height within the hopper to suit the volume of the workpiece.

In one or more embodiments, to increase mechanical advantage, the crank can be affixed instead to a crankshaft mounted parallel to the drum, the crankshaft and drum fitted with gears mated to each other. The mechanical advantage can sufficiently outweigh the added frictional losses. The lever can then be raised for greater convenience and made longer, further increasing mechanical advantage.

In one or more embodiments, to steady the grater when processing meals in the kitchen and to leave one hand free for feeding the hopper, the grater can be mounted on a stand. The stand can raise the grater above the countertop, providing more clearance for the operator's hand in turning the crank. The stand can also angle the grater so that material slides out the side of the drum. A spout can guide the material from the drum into a plate, bowl or other container. A stand is most easily mated to the geared version of the slicer/grater.

In one or more embodiments, the grater can be secured to the stand by being introduced into a receiver. Walls of the receiver can be angled to guide the grater into place and to wedge it securely into position.

In one or more embodiments, spring clips, built into the receiver can persuade the grater to remain in place by locking into indentations along the bottom of the grater.

In one or more embodiments, the stand can also house an extra grating or slicing drum. The drum can be accessed either from behind or from underneath the stand. It can be held in by spring clips.

In one or more embodiments, if the stand is made of die-cast zinc or other weighty material, it may tend to stay in place on the countertop resisting the cranking action. If not, the stand can be secured to a smooth surface by one or more suction cups. It can have feet that can lock into a clamp or weight. It can be secured by means of a bayonet-type mount that engages with spool-shaped feet.

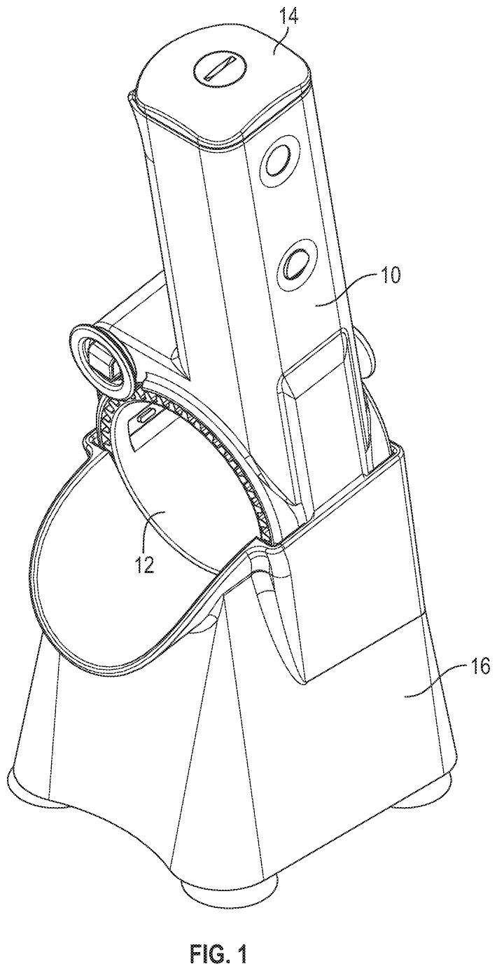

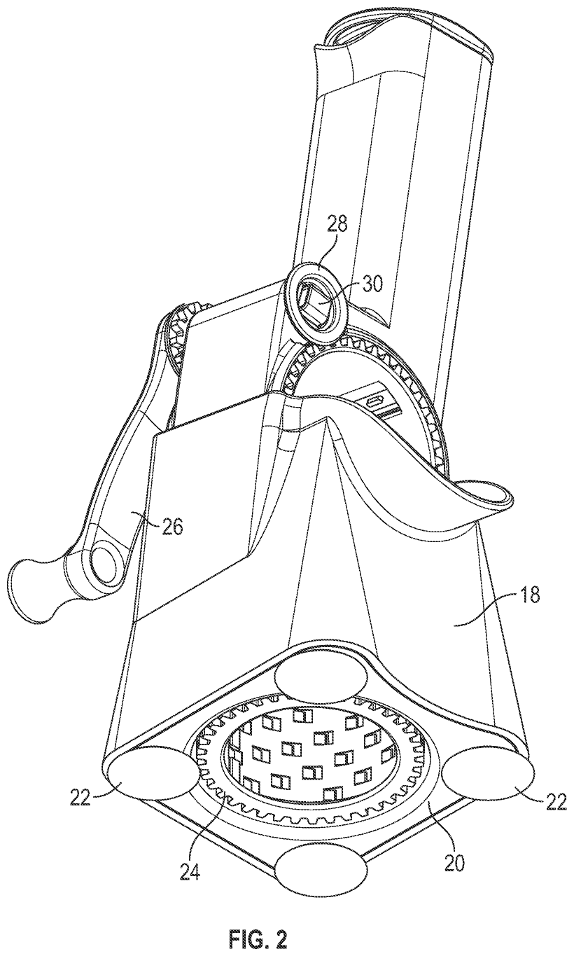

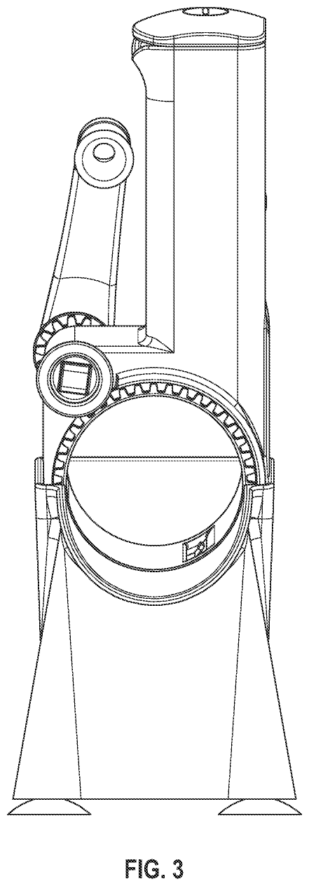

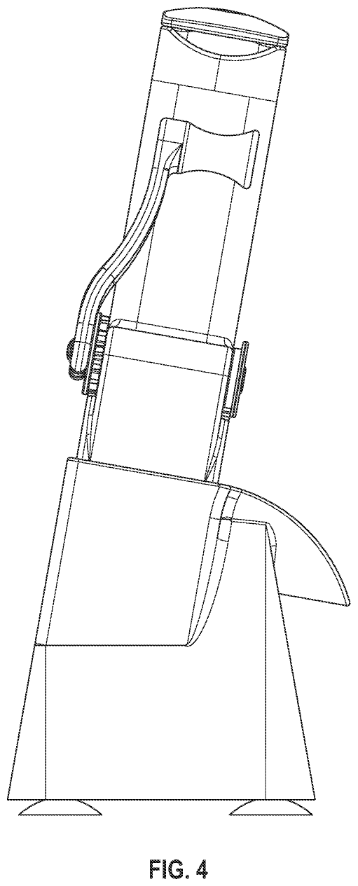

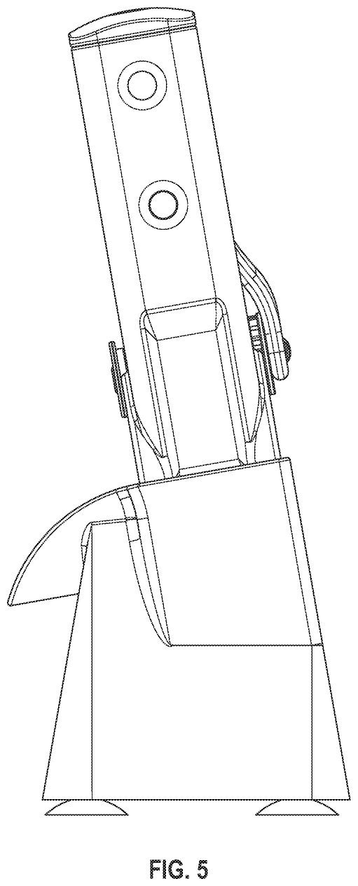

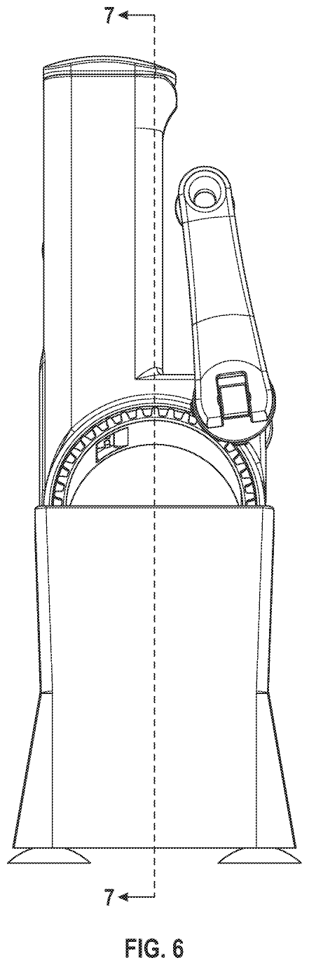

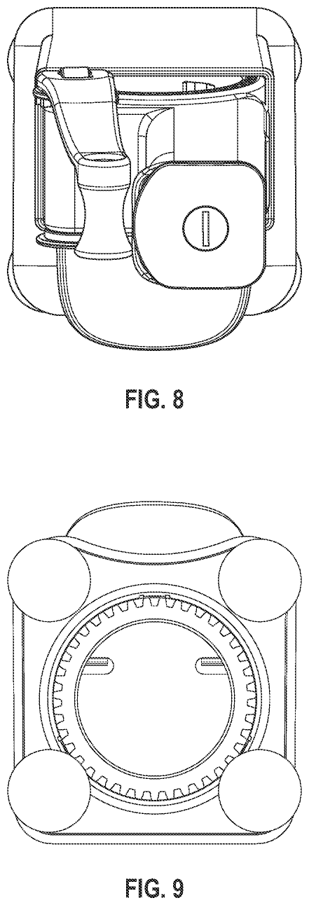

FIGS. 1-9 depict a first illustrative embodiment of a rotary grater and/or slicer 10, equipped with a geared slicing drum 12 and a hopper plunger 14. In the first illustrative embodiment, as shown in FIG. 1, the rotary grater and/or slicer 10 is mounted in a stand 16. FIG. 2 shows the stand shell 18 and the stand bottom plate 20 holding suction cups 22. The bottom plate 20 also holds a geared grating drum 24 that can be interchanged with the slicing drum. FIG. 2 also shows the pivoting crank 26 with its pivot crankshaft 28 and its pivot plunger 30. In the first illustrative embodiment, the rotary grater and/or slicer 10 is in a form of geared gravity grater with a pivot crank 26.

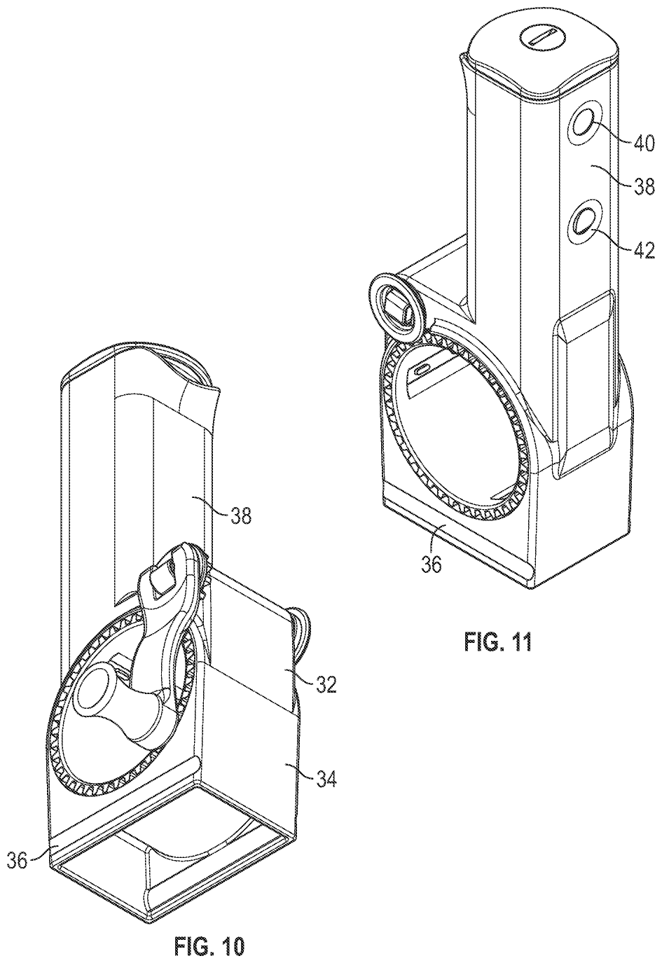

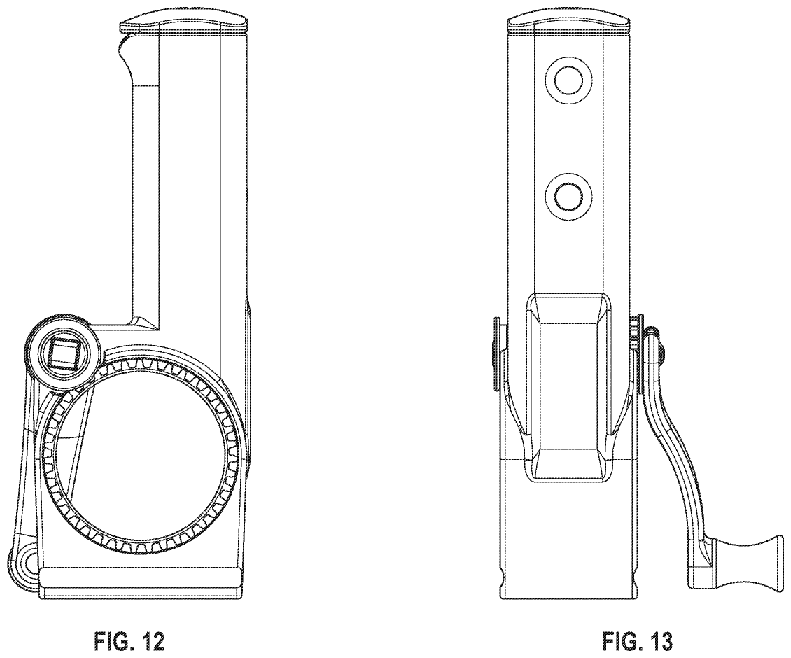

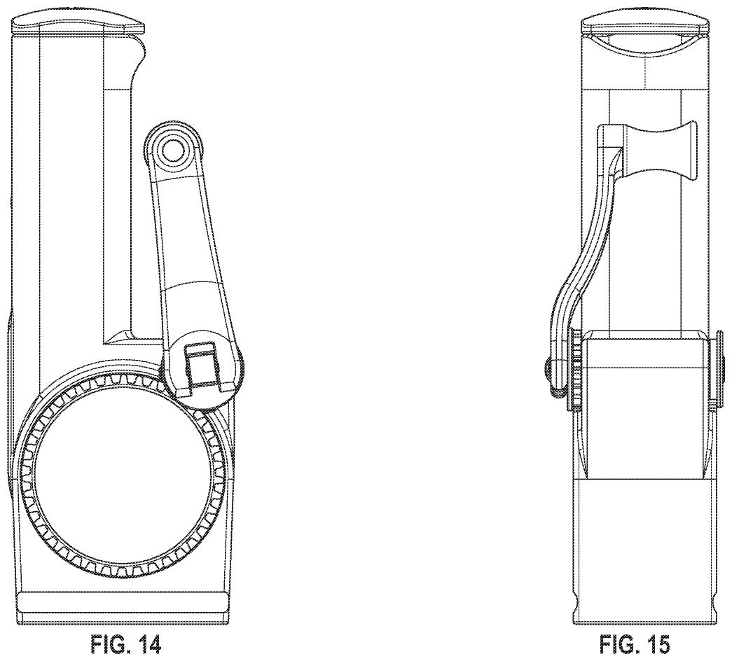

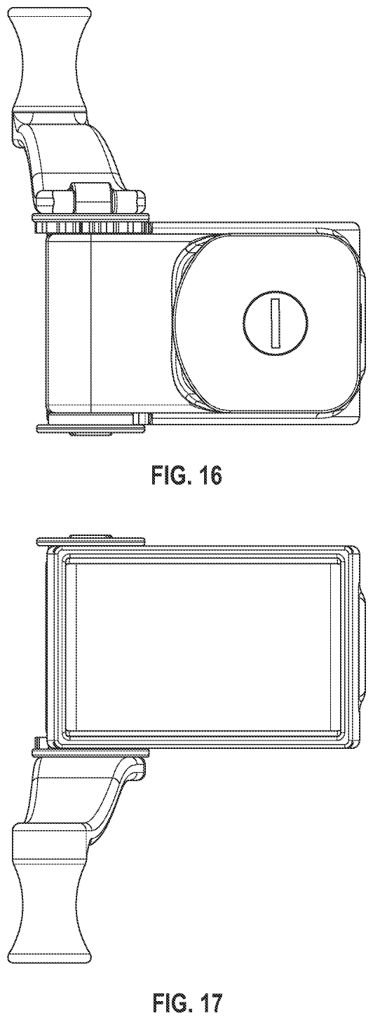

FIGS. 10-18 depict the first illustrative embodiment of the rotary grater and/or slicer 10 without the stand 16. Referring to FIGS. 10 and 11, the rotary grater and/or slicer 10 comprises the geared grater/slicer shell 32 with a lower wall forming a tapered base 34 and detent grooves 36. FIGS. 10 and 11 also show the hopper 38 with its upper hopper plunger perch 40, and its lower hopper plunger perch 42.

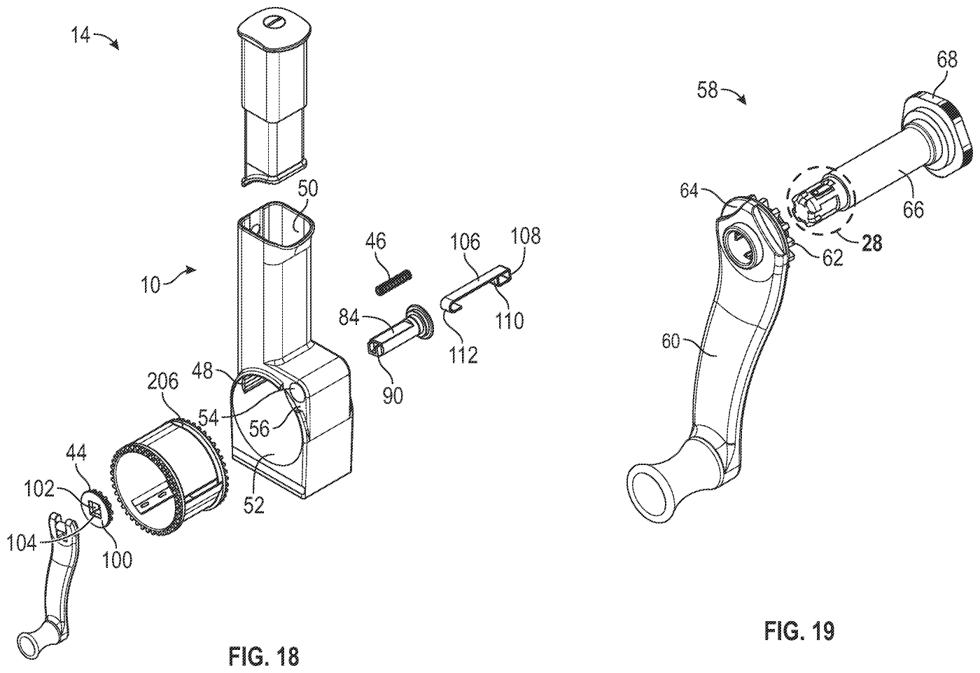

In FIG. 18, an exploded perspective view of the first illustrative embodiment of the rotary grater and/or slicer 10 is depicted. FIG. 18 shows the pivot crank gear 44 and the pivot plunger spring 46. This figure also shows the hopper anti-roll ridges 48, the hopper bore 50, the drum bore 52, and the crankshaft bore 54. Parallel surfaces on either side of the slicer/grater 10 act as geared body thrust bearings 56.

FIG. 19 shows an alternative fixed crank assembly 58, which includes a fixed crank 60 with its fixed crank gear 62 and a drum notch 64. FIG. 19 also shows a fixed crankshaft 66 with its crankshaft knob 68.

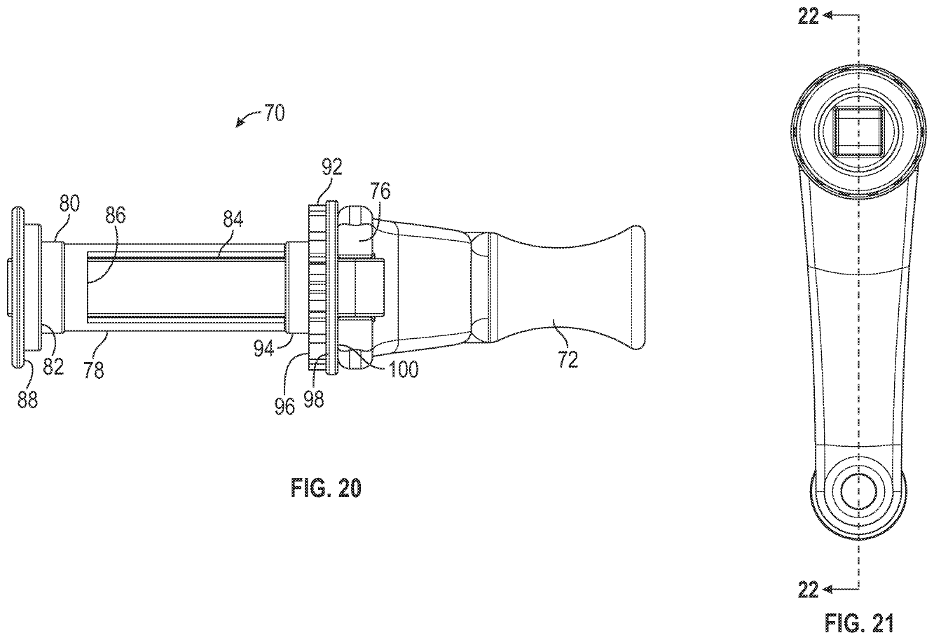

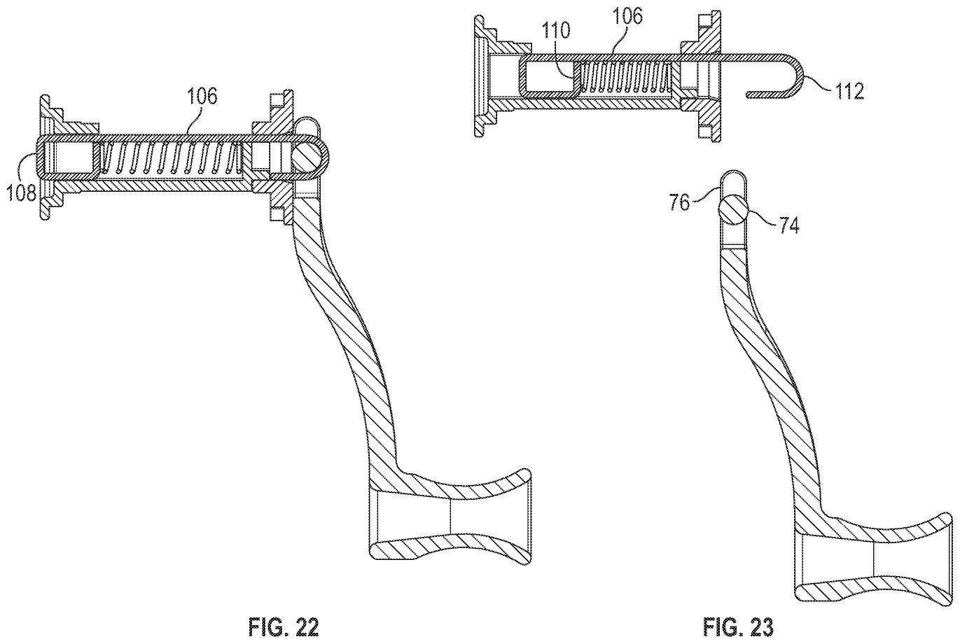

FIGS. 20-23 show the pivot crank assembly 70 used in the illustrative rotary grater and/or slicer 10. Also shown in these figures, the crank has a crank knob 72, a pivot axle 74 (shown in FIG. 23), and cams 76. The pivot crank shaft 78 has a pivot crankshaft band bearing 80, a pivot crankshaft thrust bearing 82, a plunger slot 84, a plunger slot wall 86, a pivot plunger gear guide 88, and an integrated nut 90 (see FIG. 18). The pivot plunger gear has a set of pivot plunger gear teeth 92, a pivot plunger gear band bearing 94 a pivot plunger gear thrust bearing 96, a pivot crank gear guide 98, and a crank cam bearing 100. As shown in FIG. 18, the pivot crank gear 44 has a socket 102 with taper 104 (both seen in FIG. 18). As shown in FIGS. 22 and 23, the pivot plunger has a central strap 106, with a button 108 at one end, a platform 110 perpendicular to the strap and between the button and the center, and a hook 112 on the other end.

Now, an exemplary operation of the first illustrative embodiment of the rotary grater and/or slicer will be described. In the first illustrative embodiment, the rotary grater and/or slicer is assembled for slicing by inserting the slicing drum in the drum bore with the cutters facing down towards the bottom of the hopper. The crankshaft plunger is inserted into the crankshaft channel with the hook facing into the channel and exiting through the nut. The crankshaft spring s then loaded into the channel as the crankshaft plunger platform compresses it until the crankshaft plunger can fully seat in the crankshaft. The spring can then be extended slightly so that the platform is constrained by the channel walls. This assembly can then be inserted hook-first into the crankshaft bore. For right-handers, it would be inserted from the left side according to the drawings. The pivot gear would then be applied to the opposite side of the slicer/grater, with the socket engaging the nut. Depressing the button would then extend the hook so that, with the crank knob facing away from the slicer-grater the crank axle could be inserted. Releasing the button would retract the hook, which is then guided into position by the taper.

The hopper is then held in the left hand with the barrel facing away from the user while material to be sliced is introduced into it. The hopper is then tilted a few degrees to the left and held over a collection vessel. Turning the crank in a clockwise motion should slice the material and drop it into the vessel. If the cutters fail to slice the material because it is too light, too hard or because it is rolling, the plunger can be inserted as far as possible, the barbed tab snapping into the upper or lower hopper perch. If the upper hopper perch, the plunger, after some cranking, will have to be advanced to the lower perch. To retract the plunger for cleaning after use, the barbed tab can be pressed into the hopper perch and the upper sleeve above the hopper lip be withdrawn.

For compact storage, the crank can be flipped over. Pulling the crank knob to the right, the cams force the crank shaft plunger outwards, compressing the crankshaft spring. Continuing to swing the knob in the same direction aligns it with the hopper, and the spring expands, securing it in the folded position.

To disassemble for cleaning or to switch to a grating drum, the button is depressed and the crank removed. The drum can then be exchanged.

The first illustrative embodiment of the rotary grater and/or slicer is assembled for right-hand use by fitting the crank ring on one end of the slicing drum, with the upper cutters facing forwards away from the user and the crank knob facing away from the drum towards the right. The crank is pushed up and forward against the drum. The hopper is then held in the left hand with the barrel facing the user while the drum is then inserted into the barrel. The lock ring is applied to the other end of the drum and turned back, while the crank is pushed, once again, forward. The object or material to be sliced is then fed into the top of the hopper. The hopper is then tilted a few degrees to the left and held over a collection vessel. Turning the crank in a clockwise motion should slice the material and drop it into the vessel. If the cutters fail to slice the material because it is too light, too hard or because it is rolling, the plunger can be inserted as far as possible, the barbed tab snapping into the upper or lower hopper perch. If the upper hopper perch, the plunger, after some cranking, will have to be advanced to the lower perch. To retract the plunger for cleaning after use, the barbed tab can be pressed into the hopper perch and the upper sleeve above the hopper lip be withdrawn.

For compact storage, the crank can be flipped over. Pulling the crank knob to the right, the cams force the crank shaft plunger outwards, compressing the crankshaft spring. Continuing to swing the knob in the same direction aligns it with the hopper, and the spring expands, securing it in the folded position.

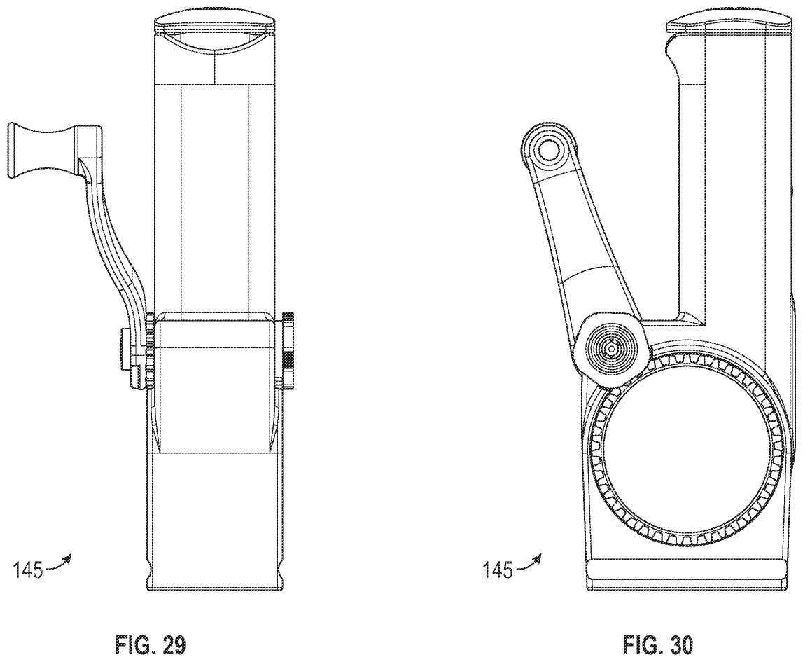

A second illustrative embodiment of the rotary grater and/or slicer is seen generally at 145 in FIGS. 29 and 30. Referring to these figures, it can be seen that, in many respects, the second illustrative embodiment is similar to the first illustrative embodiment. Moreover, many elements are common to both such embodiments. For the sake of brevity, the elements that the second embodiment of the rotary grater and/or slicer has in common with the first embodiment will not be discussed because these components have already been described above.

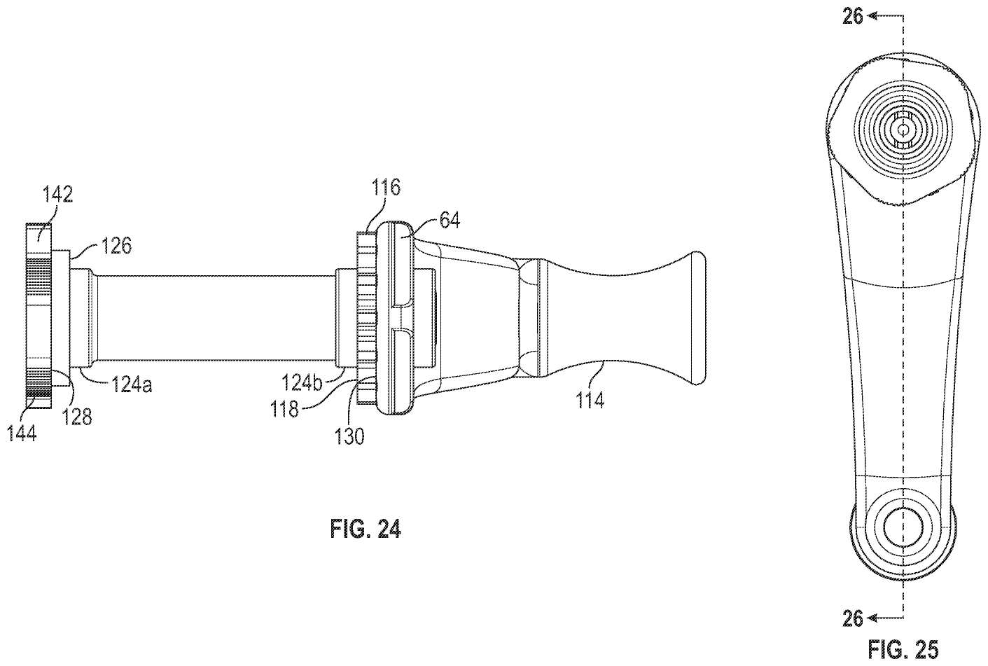

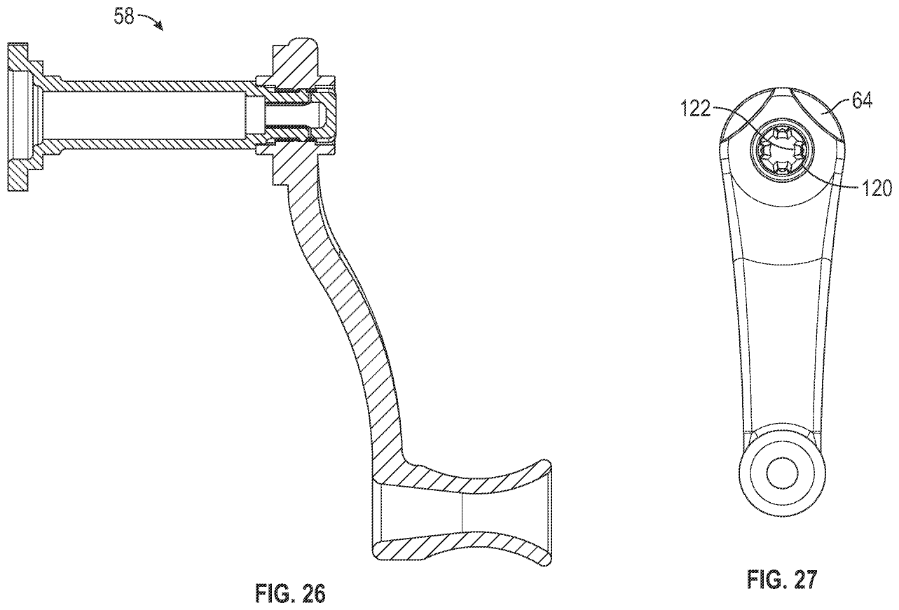

In the second illustrative embodiment, referring to FIGS. 24-30, it can be seen that the rotary grater and/or slicer 145 is in a form of geared gravity grater with a fixed crank, rather than the pivot crank described above for the first illustrative embodiment. FIGS. 29-30 show the second illustrative embodiment of the rotary grater and/or slicer 145 assembled.

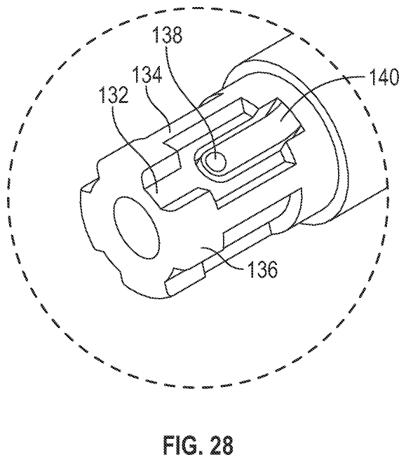

FIGS. 24-28 show the fixed crank assembly of the second illustrative embodiment. Referring to FIGS. 24 and 27, it can be seen that the fixed crank has a fixed crank knob 114, an integrated set of crank gear teeth 116, a fixed crank thrust bearing 118, and a crank bayonet bore 120. As shown in FIG. 27, the crank bayonet bore 120 has crank bayonet tabs 122. The fixed crank shaft has fixed crankshaft band bearings 124a, 124b, a fixed crankshaft thrust bearing 126, a fixed shaft gear guide 128, and a fixed crank gear guide 130 (see FIG. 24). Also, as shown in FIG. 28, the fixed crank shaft has crank tab slots 132 that broaden to permit the tabs to revolve until they rest against spline walls 134. The spline walls 134 broaden at their free ends 136 to prevent the tabs from sliding back out. Bumps 138 on sprung clips 140 prevent the tabs from revolving back and working free accidentally. Referring again to FIG. 24, the outer perimeter of the fixed crank shaft has waved edges 142 and grip grooves 144.

Now, an exemplary operation of the second illustrative embodiment of the rotary grater and/or slicer will be described. In the second embodiment, the drum is inserted as before, but the fixed crankshaft is inserted into the left side of the crankshaft bore. The fixed crank is then slid onto the end of the shaft and while the crankshaft knob is held still, twisted slightly forward. The detent then holds it in place. For storage, the crank can be twisted off and inverted. The drum notch engages with the drum to keep the crank from rotating freely. To disassemble for cleaning, the procedure is reversed. In other respects, the second embodiment operates like the first embodiment described above.

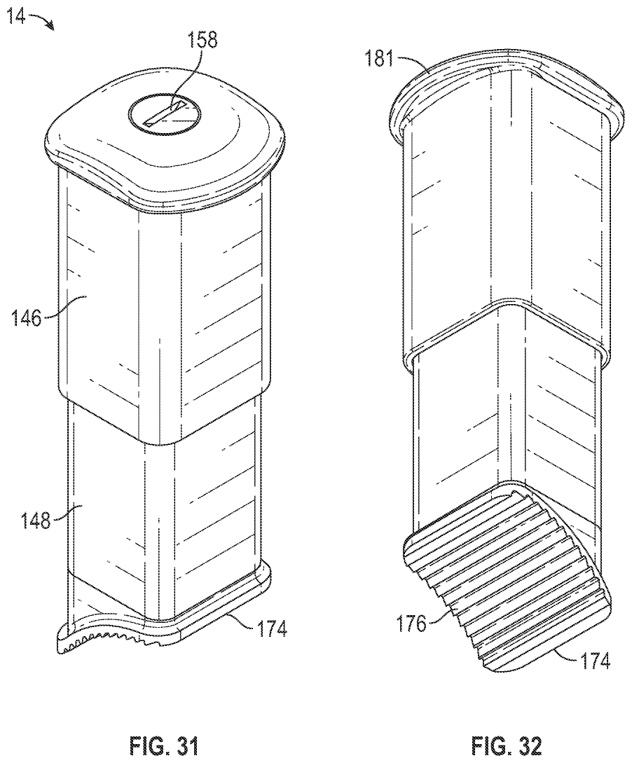

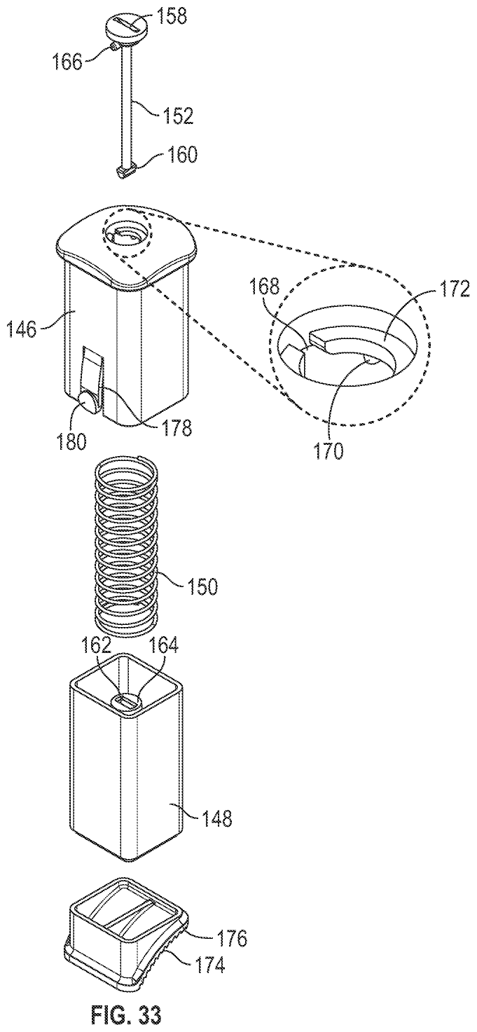

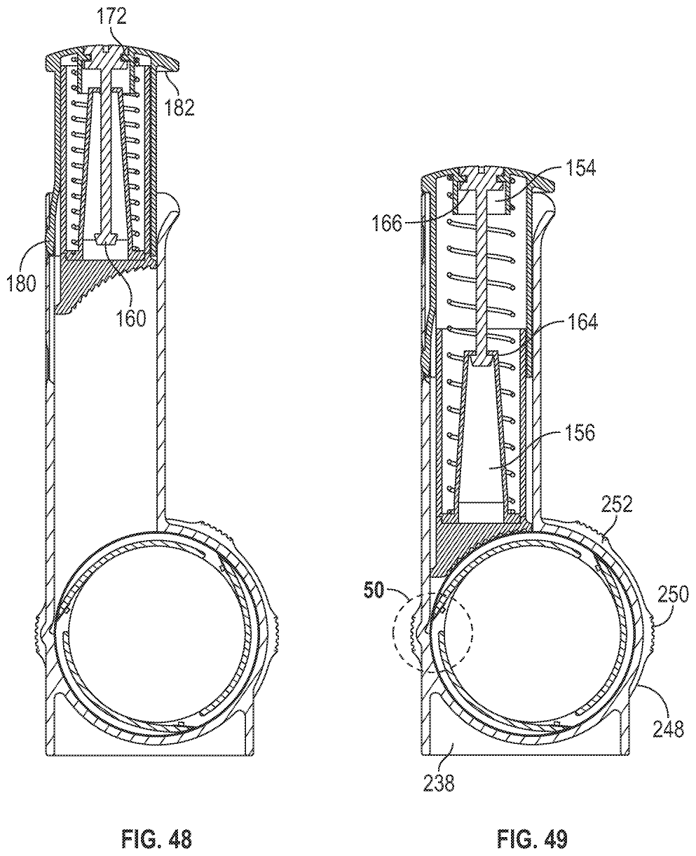

Now, the hopper plunger used in the illustrative embodiments of the rotary grater and/or slicer will be described. FIGS. 31-33 depict the hopper plunger alone, and the hopper plunger can also be seen in cross-sectional views of FIGS. 48 and 49. Referring to FIGS. 31-33, it can be seen that the hopper plunger 14 comprises an outer upper sleeve 146 telescoping over an inner lower sleeve 148, a hopper plunger spring 150 that pushes them apart, and a key 152 that hold them together. Turning to FIGS. 48 and 49, it can be seen that the spring 150 is held in place by an internal upper cup 154 affixed to the top of the upper sleeve 146 and an internal lower cup 156 affixed to the bottom of the lower sleeve 148. The key 152 can be turned by a key slot 158 that can accept a coin or screwdriver (not shown). The key 152 has lower pins 160 that pass through a lower slot 162 in the top 164 of the lower cup 156, then rotate 90 degrees to lock the sleeves 146, 148 together. Simultaneously, the upper pins 166 of the key 152 pass through an upper slot 168 in the upper cup 154, and rotate 90 degrees to be captured by dimples 170 on the underside of keyhole wall 172. A plunger face 174 bears plunger anti-roll ridges 176 that prevent smaller workpieces from rolling (refer to FIG. 32). A spring tab 178, having a barb 180 engages with the upper plunger perch 40 or lower plunger perch 42 to position the plunger to exert pressure on the workpiece according to its volume. An upper sleeve lip 181 can be used to pry the plunger from the hopper after pressing the barb inwards.

Now, an exemplary operation of the hopper plunger of the illustrative embodiment of the grater will be described. In the illustrative embodiment, to open the hopper plunger for cleaning, one can place a coin, key or screwdriver tip in the slot on the top of the key and turn ¼ counter-clockwise. Then, one can pull the upper and lower parts away from each other. To reassemble, one places the spring on the cone on the lower inner part, and slips the upper outer part over the inner lower part and compresses the spring. Finally, one inserts the key and turns it clockwise ¼ turn.

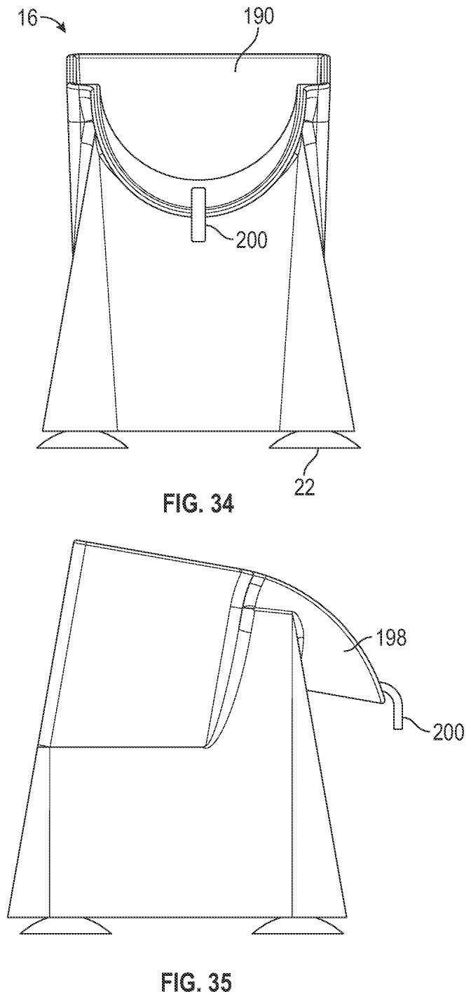

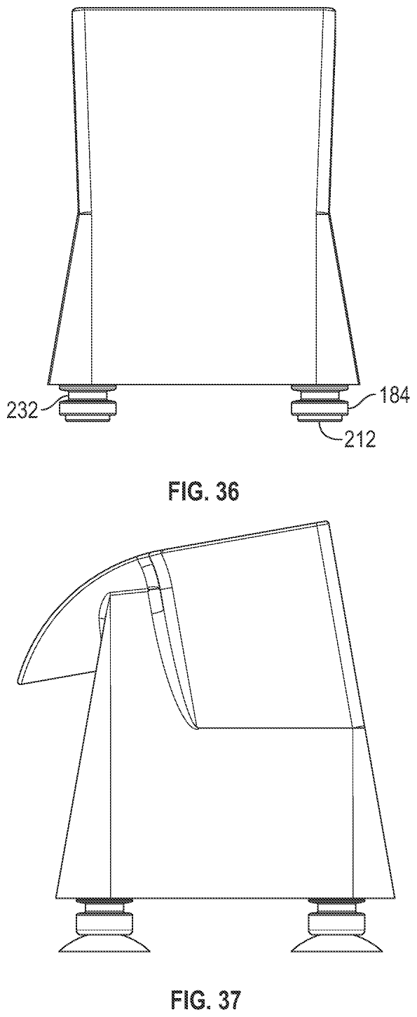

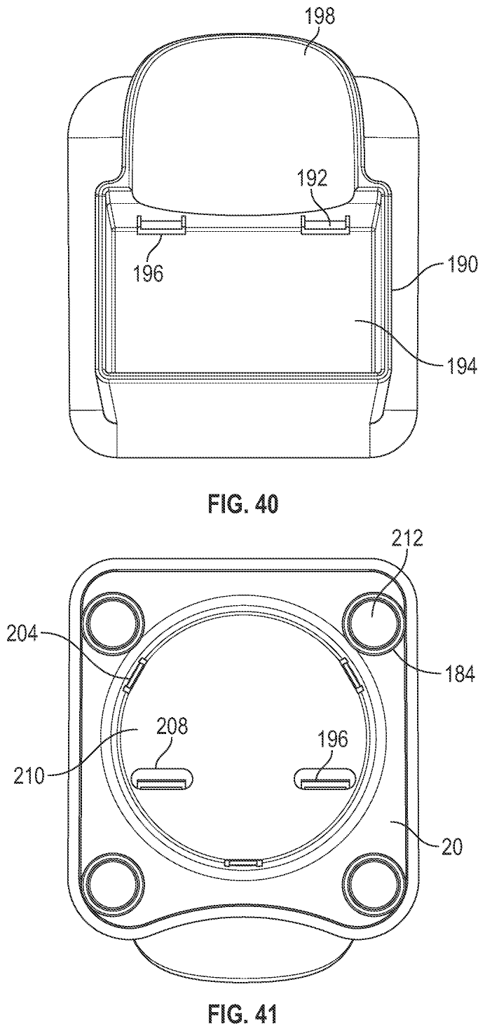

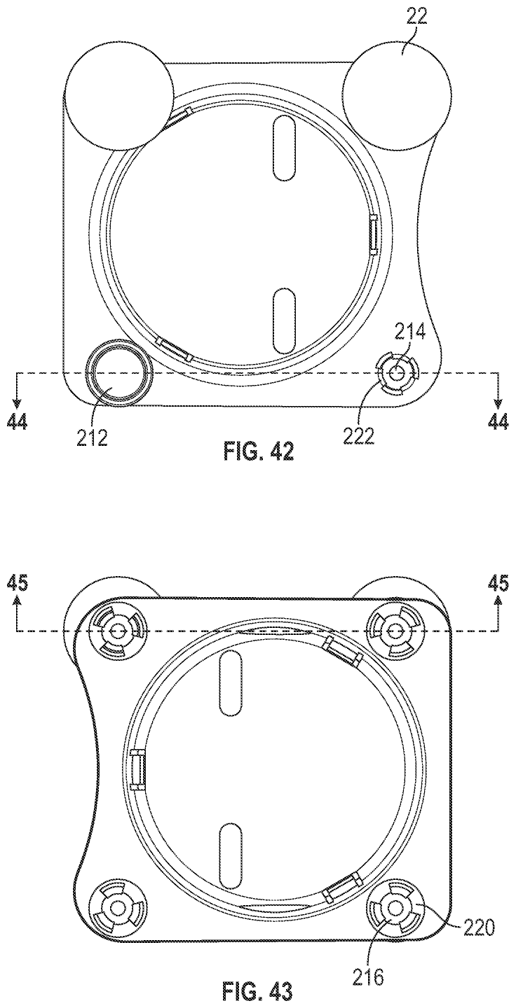

Next, the stand 16 that may be used with the illustrative embodiments of the rotary grater and/or slicer will be explained. FIGS. 34-41 show the stand alone and FIGS. 42-45 show the stand bottom plate without the stand shell. FIGS. 36 and 38-41 show padded spool feet 184 affixed to the bottom plate by screws (not shown) passing through to the stand body. Suction cups 22 can be plugged into bottom plate orifices 186 or spool foot orifices 188 as shown in FIGS. 42-45.

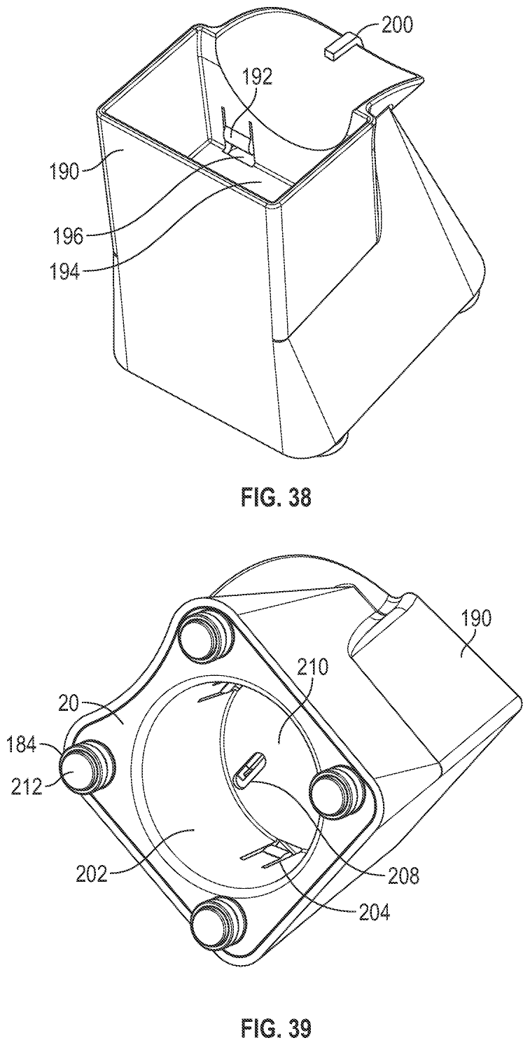

FIG. 38 shows the upper wall of the stand, which forms the slicer/grater receiver 190. A grater spring clip 192 at either side of the receiver 190 holds the tapered base of the slicer/grater 10 in place by engaging with the detent grooves 36 (see FIG. 10). The openings around the clips extend through the bottom of the receiver 194, to form upper crumb slots 196. The stand spout 198 transfers processed material 200 from the slicer/grater 10 to a receiving container (not shown).

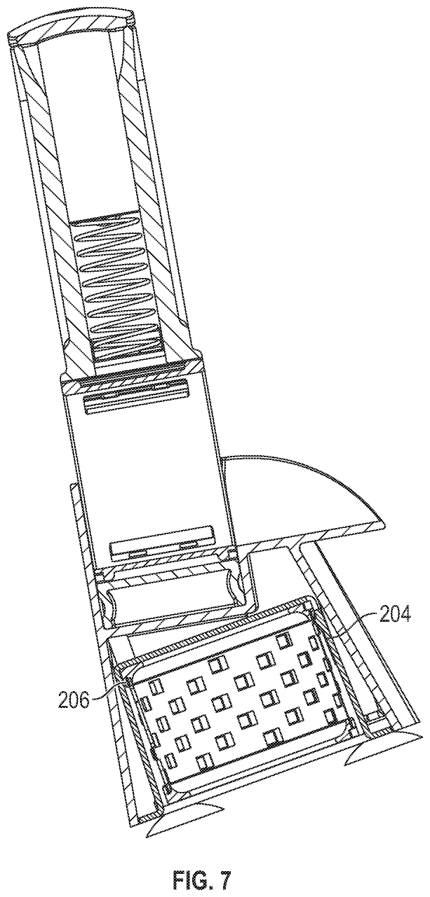

FIG. 39 shows a drum receiver 202 formed from the stand base plate that holds a spare drum. At three places in the receiver, a drum spring clip 204 can hold the drum in place by pressing against the toothed rim 206 of the slicing or grating drum (see FIGS. 7 and 18). Lower crumb slots 208 in the upper drum receiver wall 210 align with upper crumb slots in the stand shell to empty crumbs from the slicer/grater receiver 190.

FIGS. 42 and 43 show alternate methods of engaging the stand with the countertop. These figures show two suction cups 22, one padded spool foot with elastomer pad 212, empty stand screw holes 214 and surrounding screw collars 216 with stand screw chamfers 218 held above the bottom plate by collar arms 220 and suction cup landings 222.

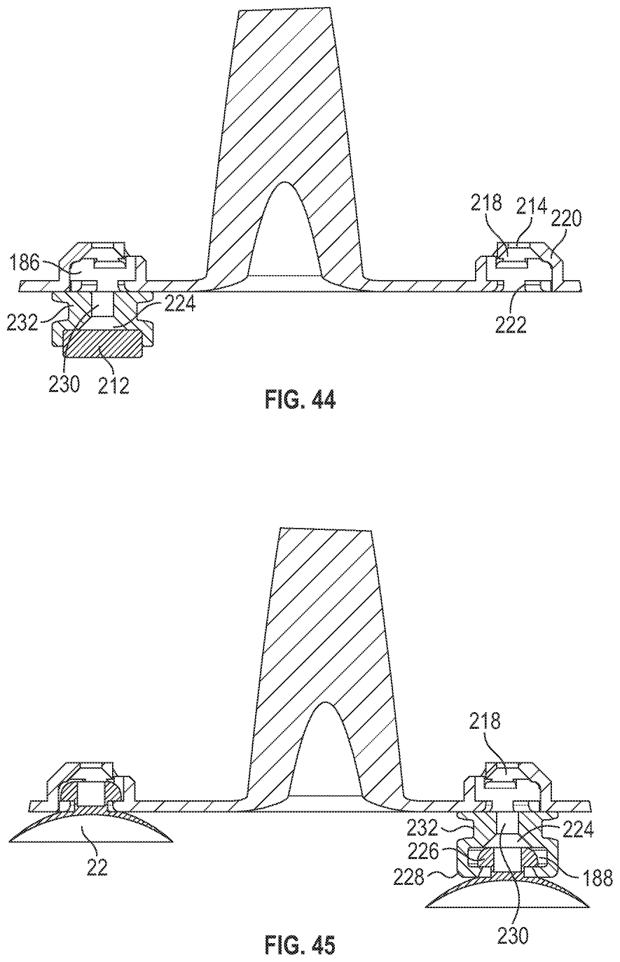

FIGS. 44 and 45 show foot screw chamfers 224 and the suction cup knob 226 that perches on the suction cup landings. FIG. 45 shows the suction-cup spool foot 228, which can also hold a suction cup via suction cup landings. The two types of spool feet each have foot screw holes 230. The spool feet also have annular necks 232 that can secure the assembly to a mounting plate (not shown) via keyhole slots. Screws (not shown) can fasten the base plate directly to the stand shell, or can clamp it between the stand shell and one or the other of the spool feet.

Now, an exemplary operation of the stand of the illustrative embodiment of the grater will be described. First, one places the stand on a countertop. Then, with the crank pointing away from the spout, one inserts the base of the first or second embodiment of the slicer/grater into the receiver atop the stand until the detents snap into the grooves.

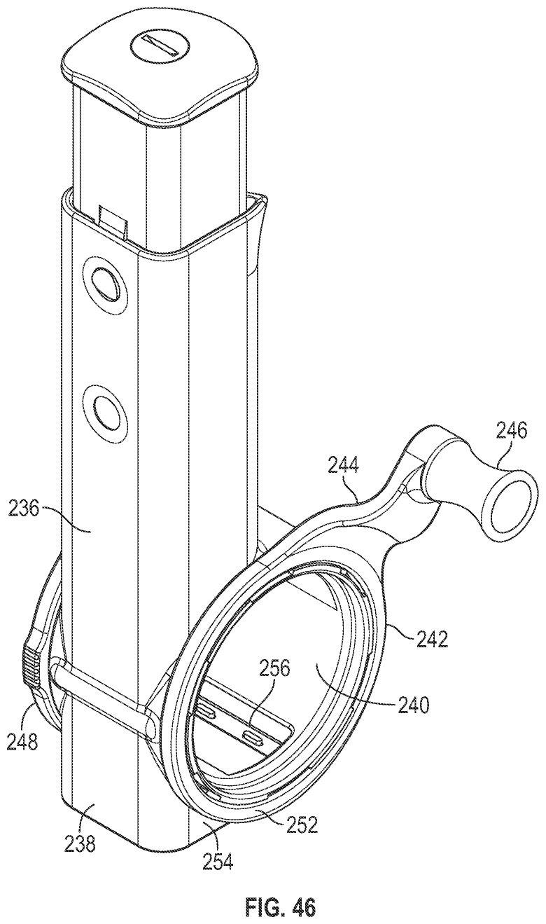

A third illustrative embodiment of the rotary grater and/or slicer is seen generally at 234 in FIGS. 46-49. Referring to these figures, it can be seen that, in many respects, the third illustrative embodiment is similar to the first and second illustrative embodiments. Moreover, many elements are common to all of the embodiments. For the sake of brevity, the elements that the third embodiment of the rotary grater and/or slicer has in common with the first and second embodiments will not be discussed because these components have already been described above.

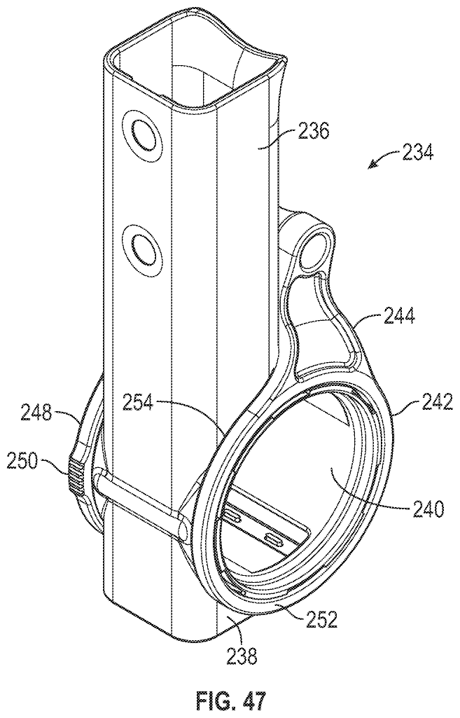

In the third illustrative embodiment, gravity rotary slicer/grater 234 does not include the gear mechanism. FIGS. 46-47 depict an overall view of the simpler slicer/grater 234 without the gear mechanism. The gravity rotary slicer/grater 234 comprises a slicer/grater shell 236 supported by a base wall 238. The housing 236, 238 of the gravity rotary slicer/grater 234 holds a unidirectional bayonet-mount slicing drum 240 centered within the drum bore. A cranked lock ring 242 is mounted around the right side of the unidirectional bayonet-mount slicing drum. A ring crank 244 extends out radially from the cranked lock ring 242, bearing a ring crank knob 246. A gripped lock ring 248, having grooved finger grips 250 arranged around the outer perimeter is mounted around the left side of the unidirectional bayonet-mount slicing drum. Identical ring flats 252 on either side of both lock rings act as thrust bearings when placed against the shell sides 254. The hopper plunger is inserted within the hopper bore, its barb mated to the upper hopper plunger perch (as shown in FIG. 46). FIG. 47 shows the same slicer/grater shell without the hopper plunger, showing the hopper bore. Also, FIG. 47 shows the cranked lock ring 242 reversed for compact storage.

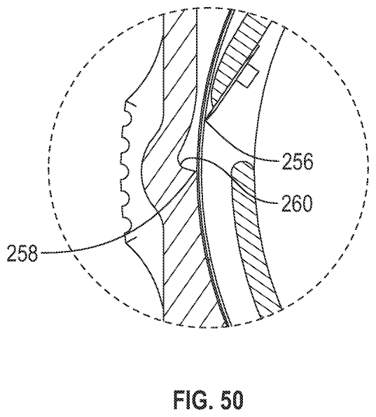

FIGS. 48-50 depict the gravity rotary slicer/grater 234 of the third illustrative embodiment in cross-section. These figures show the slicing blade 256 approaching the dam 258, which crosses the bay 260.

Now, an exemplary operation of the third illustrative embodiment of the rotary grater and/or slicer will be described. In the third embodiment, the rotary grater and/or slicer is assembled for right-hand use by fitting the crank ring on one end of the slicing drum, with the upper cutters facing forwards away from the user and the crank knob facing away from the drum towards the right. The crank is pushed up and forward against the drum. The hopper is then held in the left hand with the barrel facing the user while the drum is then inserted into the barrel. The lock ring is applied to the other end of the drum and turned back, while the crank is pushed, once again, forward. The object or material to be sliced is then fed into the top of the hopper. The hopper is then tilted a few degrees to the left and held over a collection vessel.

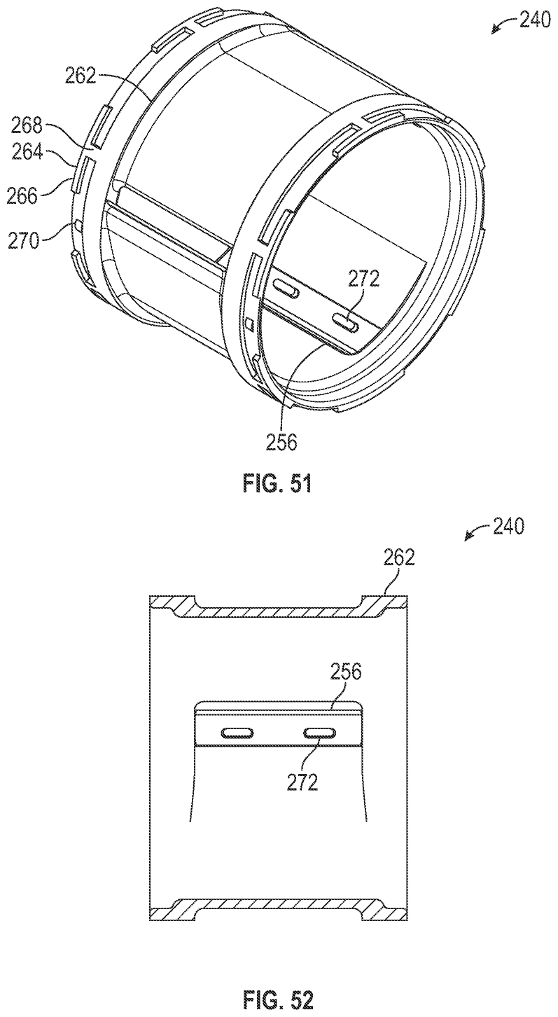

Now, the drum used in the illustrative embodiments of the rotary grater and/or slicer will be described. FIGS. 51-57 show bayonet-mount drum without gear teeth. The drum band bearing 262 rides along the inside of the drum bore, as do the toothed drums of the first illustrative embodiment. The drums are bilaterally symmetrical. T-shaped locking ridges 264 are applied to the outer cylindrical wall of the drum. T-shaped locking rib arms 266 are aligned with the ends of the drum such that the tabs of either ring can be slid between the arms of the Ts, and captured by rotating them against the T-shaped locking rib stems 268. Locking nubs 270, located on the outer walls of the drum 240 between the stems engage with the locking notches to lock the rings into place.

FIGS. 51 and 52 show the unidirectional bayonet-mount slicing drum 240 onto which slicing blades 256 have been fitted to blade bosses 272 that have then been expanded to hold the slicing blades 256 in place.

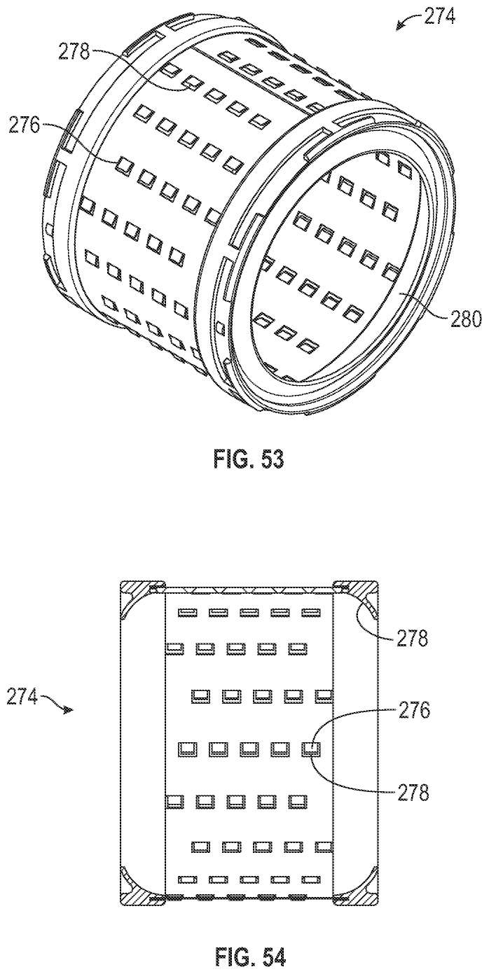

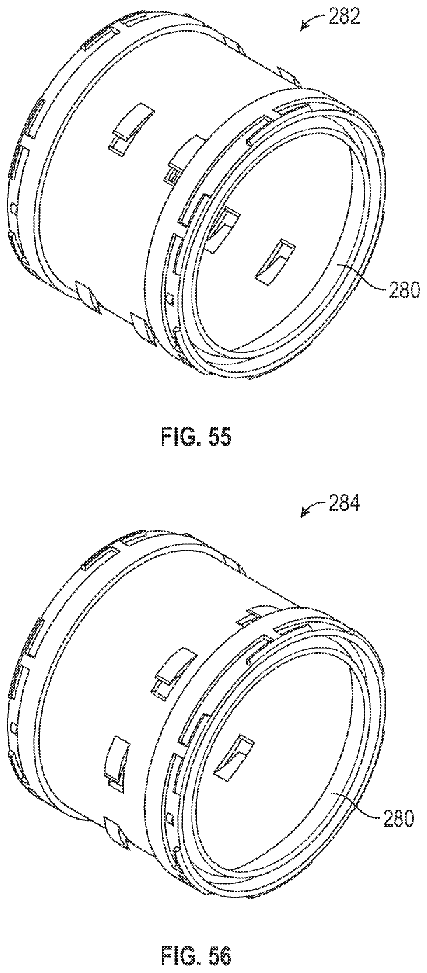

FIGS. 53 and 54 show a unidirectional fine-cutting bayonet-mount grating drum 274. The drum 274 has evenly-spaced teeth 276 with sharp leading edges 278. FIGS. 53-55 show unidirectional bayonet-mount grating drums 274 with retaining walls 280.

FIG. 55 shows a unidirectional quarter-cutting bayonet-mount grating drum 282, while FIG. 56 shows a unidirectional gradually-cutting bayonet-mount grating drum 284.

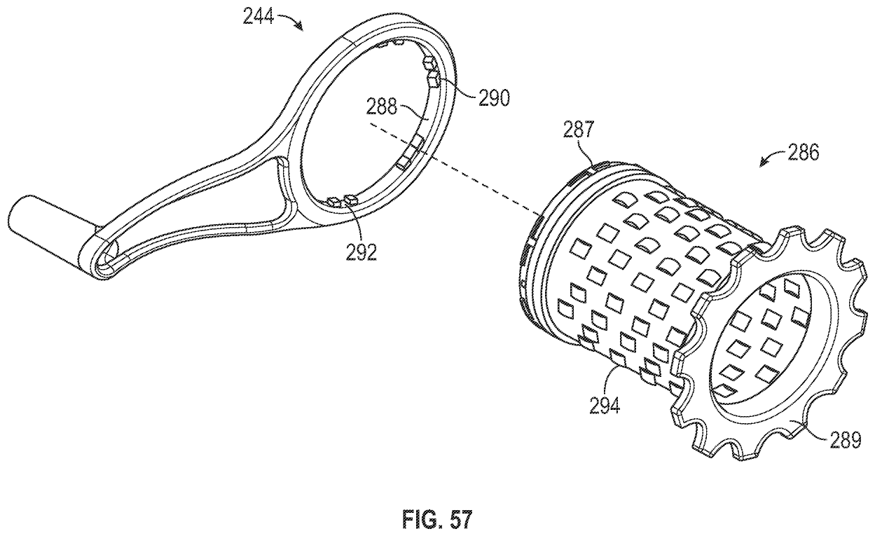

FIG. 57 shows an exploded perspective view of a bi-directional bayonet-mount grating drum 286 incorporating a lock ring 287 on one side and a cranked lock ring 289 that can be bayonet mounted on the opposite side. Despite some minor differences in the shape of the crank and knob, FIG. 57 generally represents the same crank lock ring seen in FIGS. 46 and 47. The interior of the cranked lock ring 288 bears bayonet mounting tabs 290. Central to the mounting tabs are tab detents 292. The exterior of the central portion of the bi-directional bayonet-mount grating drum bears bi-directional grating teeth 294, open arches sharpened at both edges.

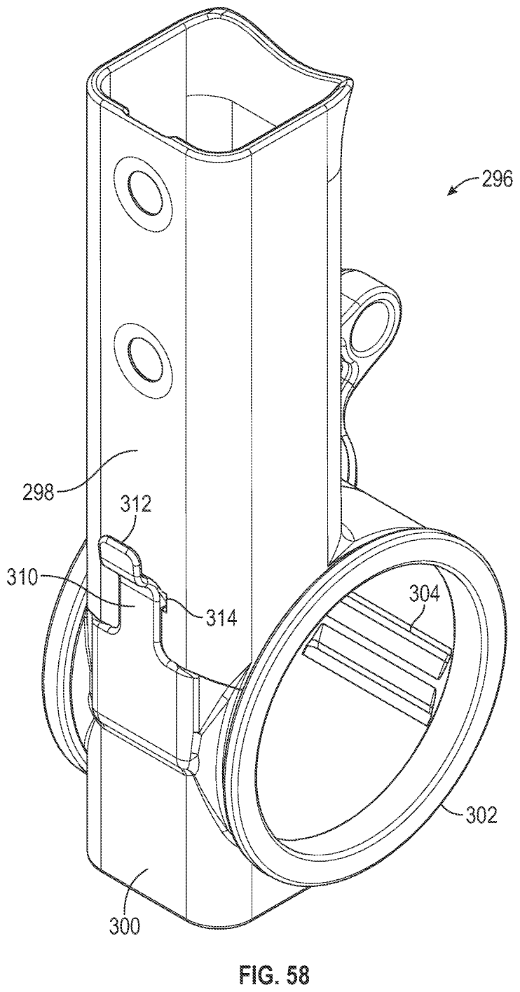

A fourth illustrative embodiment of the rotary grater and/or slicer is seen generally at 296 in FIGS. 58-61. Referring to these figures, it can be seen that, in many respects, the fourth illustrative embodiment is similar to the preceding illustrative embodiments. Moreover, many elements are common to all of the embodiments. For the sake of brevity, the elements that the fourth embodiment of the rotary grater and/or slicer has in common with the preceding embodiments will not be discussed because these components have already been described above.

In the fourth illustrative embodiment, as depicted in FIGS. 58-61, the rotary grater and/or slicer 296 is in a form of a semi-clamshell gravity rotary slicer/grater. FIG. 58 shows the gravity slicer/grater 296 with its shell divided into an upper shell 298 and a lower shell 300. The gravity slicer/grater 296 of the fourth illustrative embodiment includes a one-piece bi-directional drum 302 incorporating a crank and bi-directional slicing blades 304.

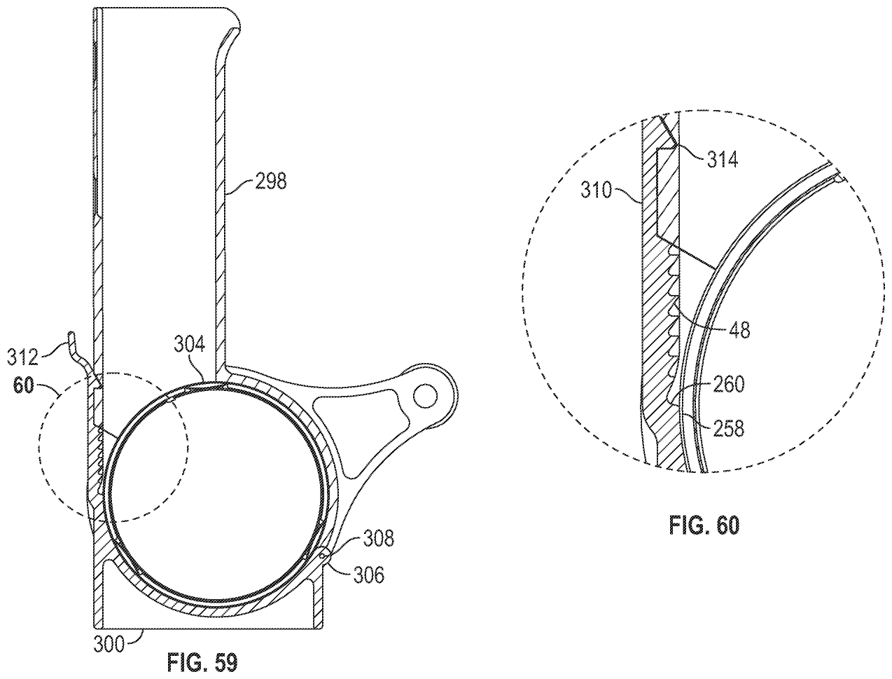

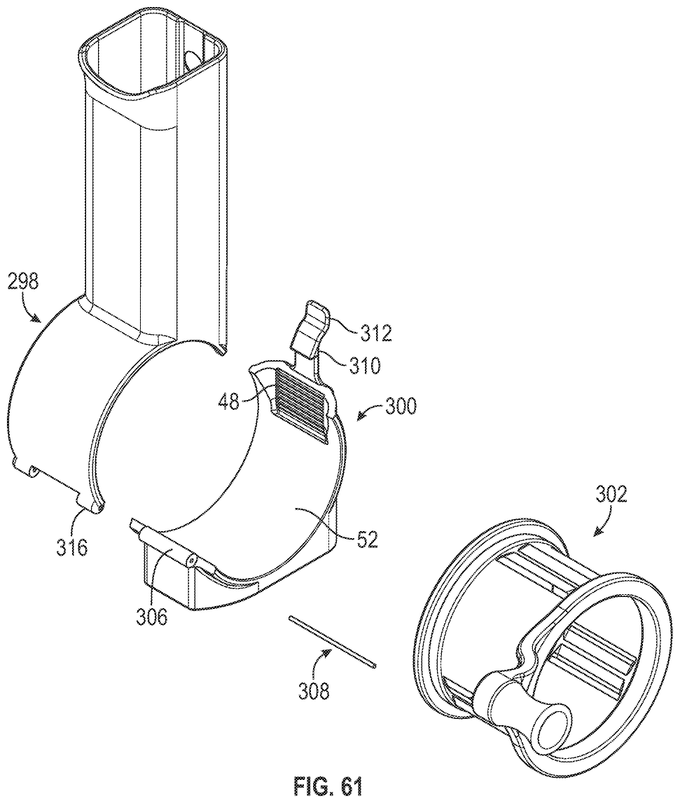

FIGS. 59 and 60 show cross-sections of the semi-clamshell gravity slicer/grater 296. These figures show the lower hinge ear 306 and hinge pin 308 and the snap clip 310 with its thumb lever 312 fitting into a snap groove 314. These figures also show the bay designed to collect material halted by the dam that bars it from being wedged between the drum and the barrel, and above that, the hopper anti-roll ridges. FIG. 61 also shows the upper hinge ears 316.

Now, an exemplary operation of the fourth illustrative embodiment of the rotary grater and/or slicer will be described. In fourth illustrative embodiment, because releasing the snap frees the drum, the drum, crank and lock ring can be made in one piece. If the slicing and grating drums are bi-directional, with blades or teeth pointing in opposite directions, the drums can be reversed for left-handers.

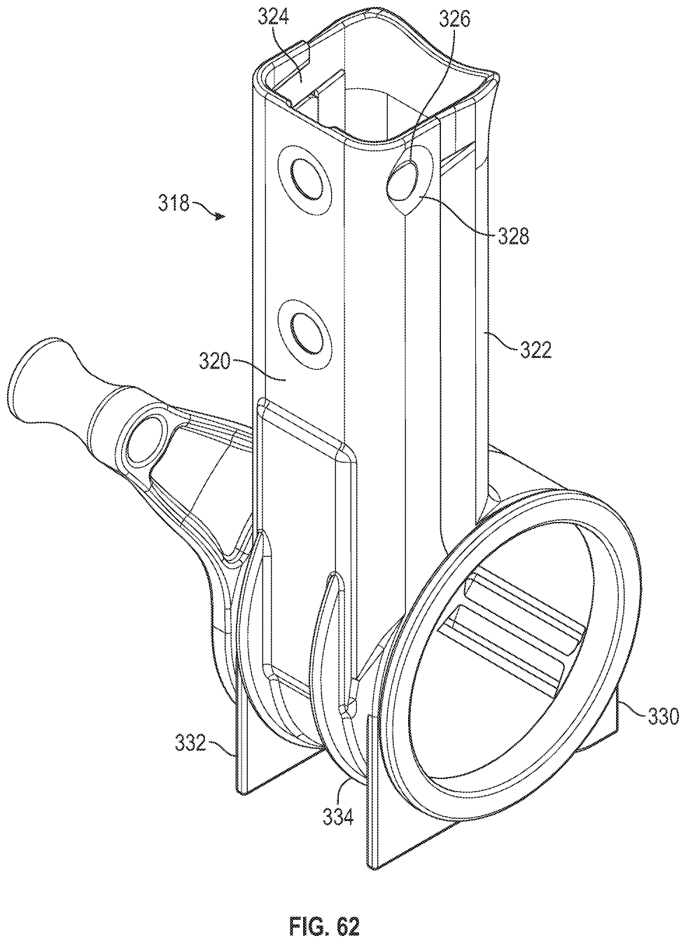

A fifth illustrative embodiment of the rotary grater and/or slicer is seen generally at 318 in FIG. 62. Referring to this figure, it can be seen that, in many respects, the fifth illustrative embodiment is similar to the preceding illustrative embodiments. Moreover, many elements are common to all of the embodiments. For the sake of brevity, the elements that the fifth embodiment of the rotary grater and/or slicer has in common with the preceding embodiments will not be discussed because these components have already been described above.

In the fifth illustrative embodiment, as depicted in FIG. 62, the rotary grater and/or slicer 296 is in a form of a clamshell gravity rotary slicer/grater 318. As shown in FIG. 62, the clamshell gravity rotary slicer/grater 318 has its shell divided into a front shell 320 and a rear shell 322. The clamshell gravity rotary slicer/grater 318 includes the one-piece bi-directional drum and crank. Hopper snaps 324 extending from the upper edge of the rear shell 322 bear hopper barbs 326 that engage with hopper perches 328 near the upper edge of the front shell 320 to join the two parts, which are hinged like the semi-clamshell version described above. Front stays 330 in front of the hinge and rear stays 332 behind it act as a base to keep the device upright. Stiffening gussets 334 reinforce the front shell 320 where it might otherwise be too thin to resist bending or breakage.

Now, an exemplary operation of the fifth illustrative embodiment of the rotary grater and/or slicer will be described. The fifth embodiment has the advantages of the fourth embodiment with the added benefit that it can be opened fully for cleaning. Furthermore, it is easier to mold and to include more anti-rolling ridges.

It is readily apparent that the aforedescribed rotary grater and/or slicer offers numerous advantages and benefits. For example, the rotary grater and/or slicer provides one or more of the following benefits: (1) reduced hand fatigue; (2) portability; (3) a smaller footprint; (4) increased tidiness; (5) accommodation to longer workpieces; (6) accommodation to sticks of butter; (7) ability to be hand-held or surface mounted; and (8) eliminates need to drill holes in walls or cabinetry.

The unique advantages of the rotary grater and/or slicer described herein may be derived from a combination of one or more the following features: (1) a vertical hopper having parallel walls, one being tangent to a rotating drum, and the distance from that wall to the opposite being less than the radius of the drum; (2) a base holding the hopper upright; (3) anti-roll ridges placed on the plunger face and/or the tangent wall; (5) a crank that folds away for storage and that can be reversed to suit users' hand preference; (6) inwardly-curved drum lips; (7) a spring-loaded plunger held together by a key; (8) a plunger that can be advanced by a clip that can secure it to any one of a number of slots; (9) a stand that holds the slicer/grater steady to enable one hand to feed; (10) the stand holding it at an angle to facilitate evacuation of product; (11) sprung tabs that secure the slicer/grater to the stand; (12) a receiver within the stand that harbors a spare drum; (13) sprung tabs that secure the drum; and (14) spool-feet that can engage with a keyholes to secure the stand.

In one or more embodiments, the disclosed slicer/grater advantageously fills the needs described above and addresses the aforementioned deficiencies by providing: a vertical hopper fed by gravity assisted by the motion of the crank, a base to stand upright, interchangeable reversible cutters, a transferable reversible crank, anti-roll ridges, inwardly-curved drum lips. It can also include an accessory spring-loaded plunger and/or a stand that raises and tilts it, can hold it securely, and that can hold an auxiliary drum.

In one or more embodiments, the disclosed slicer/grater can be used to slice or grate soft cheese, hard cheese, nuts, chocolate, butter, fruits and vegetables. In particular, it is well-adapted to process pickles, carrots, radishes and celery. It can slice bananas or sausages. It can also grind peanuts, cinnamon sticks or nutmeg.

Some features described above including, but not limited to, the bayonet mounting configuration, are described in U.S. Nonprovisional patent application Ser. No. 18/117,421 by the Applicant, and in U.S. provisional applications 63/316,418 and 63/407,724 by the Applicant, the disclosures of each of which are hereby incorporated by reference as if set forth in their entireties herein.

In one or more embodiments, a hand-held slicer/grater is disclosed in which the hopper serves as a positioning handle. Gravity funnels materials such as butter, cheese, chocolate, carrots or nutmeg into cutters mounted on a rotating drum. The rotating cutters enhance the downward gravitational force, advancing the workpiece as it is being shredded or sliced. Further downward force can be applied by a telescoping plunger. Mechanical advantage in rotating the drum can be increased by gearing. The device can be secured to a work surface by means of a dedicated stand, itself secured to the work surface by means of substantial weight or by suction cups, clips, screws or other means.

### INDEX OF ILLUSTRATED ELEMENTS

### First Embodiment of Rotary Grater and/or Slicer

10: geared slicer/grater
12: geared slicing drum
14: hopper plunger
16: stand
18: stand shell
20: stand bottom plate
22: suction cups
24: geared grating drum
26: pivoting crank
28: pivot crankshaft
30: pivot plunger
32: geared slicer/grater shell
34: tapered base
36: detent grooves
38: hopper
40: upper hopper plunger perch
42: lower hopper plunger perch
44: pivot crank gear
46: plunger spring
48: hopper anti-roll ridges
50: hopper bore
52: drum bore
54: crankshaft bore
56: geared body thrust bearings
58: fixed crank assembly
60: fixed crank
62: fixed crank gear
64: drum notch
66: fixed crankshaft
68: crankshaft knob
70: pivot crank assembly
72: crank knob
74: pivot axle
76: cams
78: pivot crankshaft
80: pivot crankshaft band bearing
82: pivot crankshaft thrust bearing
84: plunger slot
86: plunger slot wall
88: pivot plunger gear guide
90: integrated nut
92: set of pivot plunger gear teeth
94: pivot plunger gear band bearing
96: pivot plunger gear thrust bearing
98: pivot crank gear guide
100: crank cam bearing
102: socket
104: socket taper
106: central strap
108: button
110: platform
112: hook

### Second Embodiment of Rotary Grater and/or Slicer

114: fixed crank knob
116: set of crank gear teeth
118: fixed crank thrust bearing
120: crank bayonet bore
122: crank bayonet tab
124a: first fixed crankshaft band bearing
124b: second fixed crankshaft band bearing
126: pivot crankshaft thrust bearing
128: fixed shaft gear guide
130: fixed crank gear guide
132: crank tab slot
134: spline wall
136: free end
138: bump
140: sprung clip
142: waved edge
144: grip groove
145: geared slicer/grater

### Plunger of Rotary Grater and/or Slicer

146: outer upper sleeve
148: inner lower sleeve
150: hopper plunger spring
152: key
154: internal upper cup
156: internal lower cup
158: key slot
160: lower pins
162: lower slot
164: lower cup top
166: upper pins
168: upper slot
170: dimples
172: keyhole wall
174: plunger face
176: plunger anti-roll ridge
178: spring tab
180: barb
181: upper sleeve lip

### Stand of Rotary Grater and/or Slicer

184: padded spool foot
186: bottom plate orifices
188: spool foot orifices
190: slicer/grater receiver
192: grater spring clip
194: bottom of the cavity
196: upper crumb slots
198: stand spout
200: processed material
202: drum receiver
204: drum spring clip
206: toothed rim
208: lower crumb slots
210: upper drum cavity wall
212: elastomer pad
214: stand screw holes
216: screw collars
218: stand crew chamfers
220: collar arm
222: suction cup landing
224: foot screw chamfers
226: suction cup knob
228: suction-cup spool foot
230: foot screw holes
232: annular necks

### Third Embodiment of Rotary Grater and/or Slicer

234: simple slicer/grater
236: simple slicer/grater shell
238: base wall
240: unidirectional bayonet-mount slicing drum
242: cranked lock ring
244: ring crank
246: ring crank knob
248: gripped lock ring
250: grooved finger grips
252: ring flat
254: simple shell sides
256: slicer blade
258: dam
260: bay

### Drum of Rotary Grater and/or Slicer

262: drum band bearing
264: T-shaped locking ridges
266: T-shaped locking rib arms
268: locking rib stems
270: locking nubs
272: blade bosses
274: unidirectional fine-cutting bayonet-mount grating drum
276: cutting teeth
278: sharp leading edges
280: retaining walls
282: unidirectional quarter-cutting bayonet-mount grating drum
284: unidirectional gradually-cutting bayonet-mount grating drum
286: bi-directional grating drum incorporating a lock ring
287: lock ring
288: interior of the cranked lock ring
289: cranked lock ring
290: bayonet mounting tab
292: tab detent
294: bi-directional grating tooth

### Fourth Embodiment of Rotary Grater and/or Slicer

296: semi-clamshell slicer/grater
298: upper shell
300: lower shell
302: one-piece bi-directional slicing drum incorporating crank and lock ring
304: bi-directional slicing blades
306: lower hinge ear
308: hinge pin
310: snap clip
312: thumb lever
314: snap groove
316: upper hinge ear

### Fifth Embodiment of Rotary Grater and/or Slicer

318: clamshell slicer/grater
320: front shell
322: rear shell
324: hopper snap
326: hopper barb
328: hopper perch
330: front stay
332: rear stay
334: stiffening gusset

Any of the features or attributes of the above described embodiments and variations can be used in combination with any of the other features and attributes of the above described embodiments and variations as desired.

Although the rotary grater has been shown and described with respect to a certain embodiments, it is apparent that the aforedescribed rotary grater can be embodied in many different forms and that many other modifications and variations are possible without departing from the spirit and scope of the claimed invention.

Moreover, while exemplary embodiments have been described herein, one of ordinary skill in the art will readily appreciate that the exemplary embodiments set forth above are merely illustrative in nature and should not be construed as to limit the claims in any manner. Rather, the scope of the invention is defined only by the appended claims and their equivalents, and not, by the preceding description.

The invention claimed is:

1. A rotary grater and/or slicer comprising:
a grater body, the grater body including a cutter housing portion and a vertical hopper portion connected to the cutter housing portion, the vertical hopper portion of the grater body being configured to hold a workpiece for grating;
a rotatable cutting device, the rotatable cutting device configured to be rotatably disposed inside the cutter housing portion of the grater body, the rotatable cutting device comprising a plurality of blade members for grating the workpiece; and
a rotary input device coupled to the rotatable cutting device, the rotary input device configured to rotate the rotatable cutting device;
wherein the vertical hopper portion is configured to serve as a handle for the rotary grater and/or slicer, and the vertical hopper portion is used for feeding the workpiece to the rotatable cutting device.

2. The rotary grater and/or slicer according to claim 1, wherein the rotatable cutting device comprises a rotatable drum with the blade members, and the rotary input device comprises a crank connected to the rotatable drum.

3. The rotary grater and/or slicer according to claim 2, wherein one wall of the vertical hopper portion is tangent to the rotatable drum.

4. The rotary grater and/or slicer according to claim 3, wherein the one wall of the vertical hopper portion that is tangent to the rotatable drum or another wall portion beneath the one wall comprises a dam preceded by a cavity in order to discourage grated material from wedging between the rotatable drum and the grater body.

5. The rotary grater and/or slicer according to claim 3, wherein a wall area of the vertical hopper portion above the tangency is provided with sharp-edged horizontal ridges to prevent the workpiece from rolling.

6. The rotary grater and/or slicer according to claim 2, wherein the crank is mounted on one edge of the rotatable drum.

7. The rotary grater and/or slicer according to claim 6, wherein the crank is removably coupled to the rotatable drum such that the crank is able to mounted interchangeable on a first side or a second side of the rotatable drum, the first side of the rotatable drum being oppositely disposed relative to the second side of the rotatable drum.

8. The rotary grater and/or slicer according to claim 6, wherein the crank is removably coupled to the rotatable drum such that the crank is reversible from a first configuration where a handle portion of the crank projects outwardly from the rotary grater and/or slicer to a second configuration where the handle portion of the crank projects inwardly towards a centerline of the rotary grater and/or slicer, the second configuration enabling the rotary grater to be more compact for storage.

9. The rotary grater and/or slicer according to claim 2, wherein the crank is affixed to the rotatable drum by a bayonet mount.

10. The rotary grater and/or slicer according to claim 9, wherein the bayonet mount is secured by a resilient protrusion pressing out from the rotatable drum to engage a side of a tooth protruding inwards from a ring affixed to the crank.

11. The rotary grater and/or slicer according to claim 9, wherein the bayonet mount is secured by a resilient protrusion pressing out from the rotatable drum to engage a side of a tooth protruding inwards from a bore surrounding axis of the crank.

12. The rotary grater and/or slicer according to claim 2, wherein inner edges of lips of the rotatable drum are flared inwards to retain shavings when an axis of the rotatable drum is horizontal.

13. The rotary grater and/or slicer according to claim 2, wherein blade members on the rotatable drum are arranged such that the workpiece can fully contact the drum between the blade members so that the blade members are able to make clear cuts through the workpiece.

14. The rotary grater and/or slicer according to claim 1, wherein the vertical hopper portion comprises a top lip that is flared to prevent the rotary grater and/or slicer from slipping from a grip of a user.

15. The rotary grater and/or slicer according to claim 1, further comprising a stand configured to maintain the vertical hopper portion in a generally vertical orientation when rotary grater and/or slicer is not being used for grating.

16. The rotary grater and/or slicer according to claim 1, further comprising a spring-loaded plunger configured to be received within the vertical hopper portion.

17. The rotary grater and/or slicer according to claim 16, wherein the plunger is configured to be clipped into place within the vertical hopper portion.

18. The rotary grater and/or slicer according to claim 17, wherein the plunger is configured to be clipped into place at two or more locations so as to accommodate different workpiece volumes.

19. The rotary grater and/or slicer according to claim 16, wherein a workpiece engagement face of the plunger is provided with sharp-edged ridges parallel to a rotational axis of the rotatable cutting device to prevent the workpieces from rolling.

20. The rotary grater and/or slicer according to claim 16, wherein sections of the plunger are held together by a rotatable key.

21. The rotary grater and/or slicer according to claim 1, further comprising a plurality of gears to provide a mechanical advantage for a user of the rotary grater and/or slicer.

22. The rotary grater and/or slicer according to claim 21, wherein one or more outer rims of the rotatable cutting device are provided with one or more of the plurality of gears that engage with a spur gear mounted on a crank or crankshaft.
